(19) United States
(12) Patent Application Publication
(10) Pub. No.: US 2024/0227541 A9
(43) Pub. Date: Jul. 11, 2024

(54) THERMAL MANAGEMENT SYSTEM, SWITCHING VALVE, AND METHOD OF CONTROLLING THERMAL MANAGEMENT SYSTEM

(71) Applicant: TOYOTA JIDOSHA KABUSHIKI KAISHA, Aichi-ken (JP)

(72) Inventor: Tomoaki SUZUKI, Nagoya-shi (JP)

(21) Appl. No.: 18/466,823

(22) Filed: Sep. 14, 2023

(30) Foreign Application Priority Data
Oct. 24, 2022 (JP) 2022-169616

(51) Int. Cl. B60K 11/04; F16K 11/085; H01M 10/613; H01M 10/625; H01M 10/63; H01M 10/6568

(52) U.S. Cl. CPC B60K 11/04; F16K 11/0856; H01M 10/613; H01M 10/625; H01M 10/63; H01M 10/6568; H01M 2220/20

(57) ABSTRACT

A thermal management circuit has a LT circuit including a reservoir tank and a battery circuit not including the reservoir tank. The thermal management system includes an ECU that controls a five-way valve to switch a plurality of modes with regard to a flow path for a heat medium in the thermal management circuit. The plurality of modes include a first mode (first circuit mode) and a second mode (third circuit mode). The first mode is a mode in which the LT circuit and the battery circuit are connected together in series. The second mode is a mode in which the LT circuit and the battery circuit are connected together in parallel and part of the heat medium flowing in the battery circuit flows to the LT circuit via the five-way valve.

### CROSS REFERENCE TO RELATED APPLICATIONS

This nonprovisional application is based on Japanese Patent Application No. 2022-169616 filed on Oct. 24, 2022 with the Japan Patent Office, the entire contents of which are hereby incorporated by reference.

### BACKGROUND

### Field

The present disclosure relates to a thermal management system, a switching valve, and a method of controlling the thermal management system.

### Description of the Background Art

A thermal management system mounted on an electrically powered vehicle has been proposed. A vehicle thermal management system (200) disclosed in U.S. Patent Publication No. 2021/0331554 includes a vehicle heat pump system (202), a battery system coolant loop (204), a drive train coolant loop (206), and a coolant valve system (208) (see FIG. 2). The vehicle thermal management system has a plurality of modes (see paragraph [0073]). In a first mode, the battery system coolant loop and the drive train coolant loop are connected together in parallel by the coolant valve system. In the second mode, the battery system coolant loop and the drive train coolant loop are connected together in series by the coolant valve system. In the third mode, the battery system coolant loop and the drive train coolant loop are connected together partially in parallel and partially in series by the coolant valve system.

### SUMMARY

In the vehicle thermal management system (200) disclosed in U.S. Patent Publication No. 2021/0331554, the drive train coolant loop (206) includes a reservoir (344) in addition to a pump (346, 347), a tee fitting (349), a power converter (304), an inverter (302), and a radiator (236). On the other hand, the battery system coolant loop (204) only includes a pump (338, 340), a battery system (106), a chiller (220), and a pump (340) (see paragraph and FIG. 3). That is, the battery system coolant loop (204) is provided with no reservoir.

With such a circuit configuration, when the heat medium circulates in each of the two circuits connected together in parallel (the first heating mode in U.S. Patent Publication No. 2021/0331554), expansion (pressure increase) of the heat medium due to a temperature change of the heat medium is not absorbed in the circuit (the battery system coolant loop in U.S. Patent Publication No. 2021/0331554) provided with no reservoir, with the result that the internal pressure of the circuit may be excessively increased. This can result in a trouble such as deterioration of a component of the circuit.

The present disclosure has been made to solve the above-described problem and has an object to prevent a trouble due to expansion of a heat medium even when a reservoir is provided in only one of two circuits connected together in parallel.

(1) A thermal management system according to a first aspect of the present disclosure includes a thermal management circuit in which a heat medium flows. The thermal management circuit has a first circuit including a reservoir and a second circuit not including the reservoir. The thermal management system further includes: a switching valve including a plurality of ports each connected to the first circuit or the second circuit; and a controller that controls the switching valve to switch a plurality of modes with regard to a flow path for the heat medium in the thermal management circuit. The plurality of modes include a first mode and a second mode. The first mode is a mode in which the first circuit and the second circuit are connected together in series. The second mode is a mode in which the first circuit and the second circuit are connected together in parallel and part of the heat medium flowing in the second circuit flows to the first circuit via the switching valve.

In the second mode of the configuration (1), the part of the heat medium flowing in the second circuit flows to the first circuit via the switching valve. Thus, pressure increase of the heat medium in the second circuit can be absorbed by the reservoir provided in the first circuit. Therefore, even when the reservoir is provided only in the first circuit of the first circuit and the second circuit, a trouble due to expansion of the heat medium can be prevented.

(2) The plurality of modes further include a third mode. The third mode is a mode in which the first circuit and the second circuit are connected together in parallel so as to avoid mixing of the heat medium flowing in the first circuit and the heat medium flowing in the second circuit.

In the third mode of the configuration (2), the heat medium flowing in the first circuit and the heat medium flowing in the second circuit are not mixed. Therefore, according to the configuration (2), the temperature of the first circuit and the temperature of the second circuit can be controlled separately (completely independently).

(3) The plurality of ports are at least four ports. The at least four ports include two ports each connected to the first circuit and two other ports each connected to the second circuit.

According to the configuration (3), by using the switching valve including the at least four ports, prevention of a trouble due to expansion of the heat medium can be suitably realized.

(4) The thermal management system is mounted on a vehicle including a driving device and a battery. The first circuit is a circuit in which the heat medium flows to exchange heat with the driving device. The second circuit is a circuit in which the heat medium flows to exchange heat with the battery.

According to the configuration (4), the reservoir is provided only in the circuit that performs heat exchange with the driving device, and even when expansion of the heat medium occurs due to the heat exchange with the battery, a trouble due to the expansion of the heat medium can be prevented.

(5) The thermal management circuit further includes a third circuit in which the heat medium flows to bypass the battery, the third circuit not including the reservoir. The plurality of modes further include a fourth mode. The fourth mode is a mode in which the first circuit and the third circuit are connected together in series.

According to the configuration (5), the heat medium can bypass the battery, i.e., the heat medium can be avoided from flowing through the battery. Therefore, the temperature of the first circuit can be adjusted without being affected by the temperature of the battery.

(6) A switching valve according to a second aspect of the present disclosure is connected to a thermal management circuit including a first circuit and a second circuit. The switching valve includes: a case provided with a plurality of ports each connected to the first circuit or the second circuit; and a valve body that is accommodated in the case and that controls flow of a heat medium. The valve body is provided with a communication portion that is able to switch a plurality of patterns with regard to a manner of communication of the heat medium between the plurality of ports. The plurality of patterns include a first pattern and a second pattern. The first pattern is a pattern in which the first circuit and the second circuit are connected together in series. The second pattern is a pattern in which the first circuit and the second circuit are connected together in parallel and part of the heat medium flowing in the second circuit flows to the first circuit via the valve body.

According to the configuration (6), as with the configuration (1), a trouble due to expansion of the heat medium can be prevented.

(7) The plurality of ports are at least four ports. The at least four ports include two ports each connected to the first circuit and two other ports each connected to the second circuit.

According to the configuration (7), as with the configuration (3), by using the switching valve including the at least four ports, prevention of a trouble due to expansion of the heat medium can be suitably realized.

(8) The case includes a first space to which at least three ports of the at least four ports are connected, and a second space to which at least one port of the at least four ports is connected. The first space and the second space are partitioned by the valve body. The first space is divided into a plurality of spaces by a plurality of partition walls. The communication portion includes a first communication portion that communicates two spaces of the plurality of spaces with each other, and a second communication portion that communicates the first space and the second space with each other.

According to the configuration (8), although details will be described later, the first pattern and the second pattern can be suitably realized.

(9) In a method of controlling a thermal management system according to a third aspect of the present disclosure, the thermal management system includes a thermal management circuit and a switching valve. The thermal management circuit has a first circuit including a reservoir and a second circuit not including the reservoir. The switching valve includes a plurality of ports each connected to the first circuit or the second circuit. The method includes controlling the switching valve to switch a plurality of modes with regard to a flow path for a heat medium in the thermal management circuit. The plurality of modes include a first mode and a second mode. The first mode is a mode in which the first circuit and the second circuit are connected together in series. The second mode is a mode in which the first circuit and the second circuit are connected together in parallel and part of the heat medium flowing in the second circuit flows to the first circuit via the switching valve.

According to the method (9), as with the configuration (1), a trouble due to expansion of the heat medium can be prevented.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing an exemplary overall configuration of a thermal management system according to a first embodiment of the present disclosure.

FIG. 2 is a diagram showing an exemplary configuration of a thermal management circuit according to the first embodiment.

FIG. 3 is a perspective view showing an exemplary external appearance configuration of a five-way valve.

FIG. 4 is a perspective view showing an exemplary configuration of a valve body.

FIG. 5 is a first diagram for illustrating a manner of flow of a heat medium inside the five-way valve according to the first embodiment.

FIG. 6 is a second diagram for illustrating a manner of flow of the heat medium inside the five-way valve.

FIG. 7 is a conceptual diagram showing an overview of a first communication pattern by the five-way valve.

FIG. 8 is a conceptual diagram showing an overview of a second communication pattern by the five-way valve.

FIG. 9 is a conceptual diagram showing an overview of a third communication pattern by the five-way valve.

FIG. 10 is a conceptual diagram showing an overview of a fourth communication pattern by the five-way valve.

FIG. 11 is a diagram for illustrating a first circuit mode according to the first embodiment.

FIG. 12 is a diagram for illustrating a second circuit mode according to the first embodiment.

FIG. 13 is a diagram for illustrating a third circuit mode according to the first embodiment.

FIG. 14 is a diagram for illustrating a pressure distribution of the heat medium in the third circuit mode according to the first embodiment.

FIG. 15 is a diagram for illustrating a fourth circuit mode according to the first embodiment.

FIG. 16 is a second diagram for illustrating a manner of flow of a heat medium inside a five-way valve according to a modification of the first embodiment.

FIG. 17 is a diagram for illustrating a first circuit mode according to the modification of the first embodiment.

FIG. 18 is a diagram for illustrating a second circuit mode according to the modification of the first embodiment.

FIG. 19 is a diagram for illustrating a third circuit mode according to the modification of the first embodiment.

FIG. 20 is a diagram for illustrating a pressure distribution of the heat medium in the third circuit mode according to the modification of the first embodiment.

FIG. 21 is a diagram for illustrating a fourth circuit mode according to the modification of the first embodiment.

FIG. 22 is a diagram showing an exemplary overall configuration of a thermal management system according to a second embodiment of the present disclosure.

FIG. 23 is a diagram showing an exemplary configuration of the thermal management circuit according to the second embodiment.

FIG. 24 is a conceptual diagram showing an overview of a first communication pattern by an eight-way valve.

FIG. 25 is a conceptual diagram showing an overview of a second communication pattern by the eight-way valve.

FIG. 26 is a conceptual diagram showing an overview of a third communication pattern by the eight-way valve.

FIG. 27 is a conceptual diagram showing an overview of a fourth communication pattern by the eight-way valve.

FIG. 28 is a conceptual diagram showing an overview of a fifth communication pattern by the eight-way valve.

FIG. 29 is a conceptual diagram showing an overview of a sixth communication pattern by the eight-way valve.

FIG. 30 is a diagram for illustrating a first circuit mode according to the second embodiment.

FIG. 31 is a diagram for illustrating a second circuit mode according to the second embodiment.

FIG. 32 is a diagram for illustrating a third circuit mode according to the second embodiment.

FIG. 33 is a diagram for illustrating a fourth circuit mode according to the second embodiment.

FIG. 34 is a diagram for illustrating a fifth circuit mode according to the second embodiment.

FIG. 35 is a diagram for illustrating a sixth circuit mode according to the second embodiment.

### DESCRIPTION OF THE PREFERRED EMBODIMENTS

Hereinafter, embodiments of the present disclosure will be described in detail with reference to figures. It should be noted that in the figures, the same or corresponding portions are denoted by the same reference characters and will not be described repeatedly. In the figure, the upward side in the vertical direction is indicated by a z axis. The upward side in the vertical direction will be simply referred to as the upward side.

The following illustratively describes a configuration in which a thermal management system according to the present disclosure is mounted on a vehicle. The vehicle is preferably a vehicle including a battery for traveling, such as a battery electric vehicle (BEV). The vehicle may be a hybrid electric vehicle (HEV), a plug-in hybrid electric vehicle (PHEV), or a fuel cell electric vehicle (FCEV). However, the purpose of use of the thermal management system according to the present disclosure is not limited to the use in a vehicle.

### First Embodiment

<Overall Configuration>

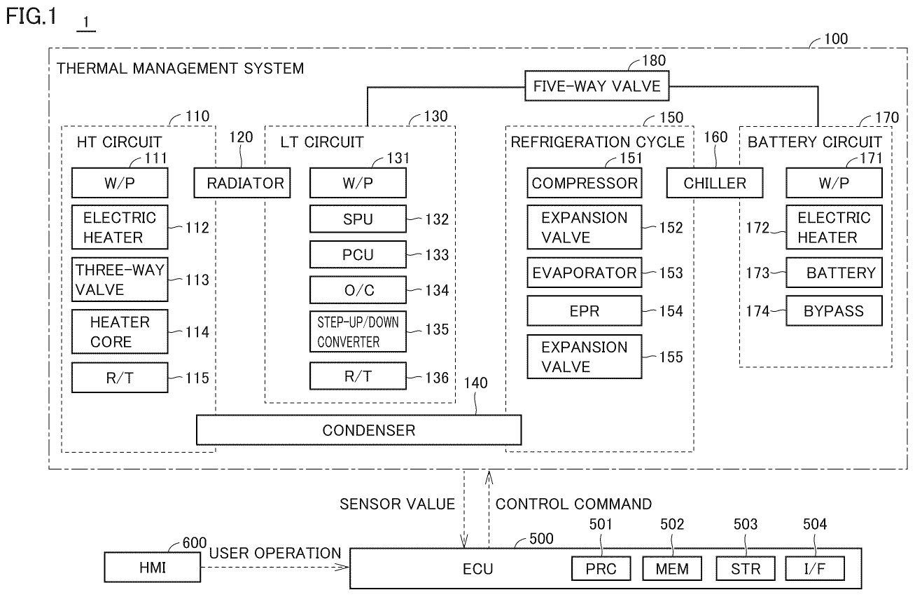

FIG. 1 is a diagram showing an exemplary overall configuration of a thermal management system according to a first embodiment of the present disclosure. Thermal management system 1 includes a thermal management circuit 100, an electronic control unit (ECU) 500, and an HMI (Human Machine Interface) 600.

Thermal management circuit 100 is configured to allow a heat medium to flow therein. Thermal management circuit 100 includes, for example, a high-temperature (HT) circuit 110, a radiator 120, a low-temperature (LT) circuit 130, a condenser 140, a refrigeration cycle 150, a chiller 160, a battery circuit 170, and a five-way valve 180.

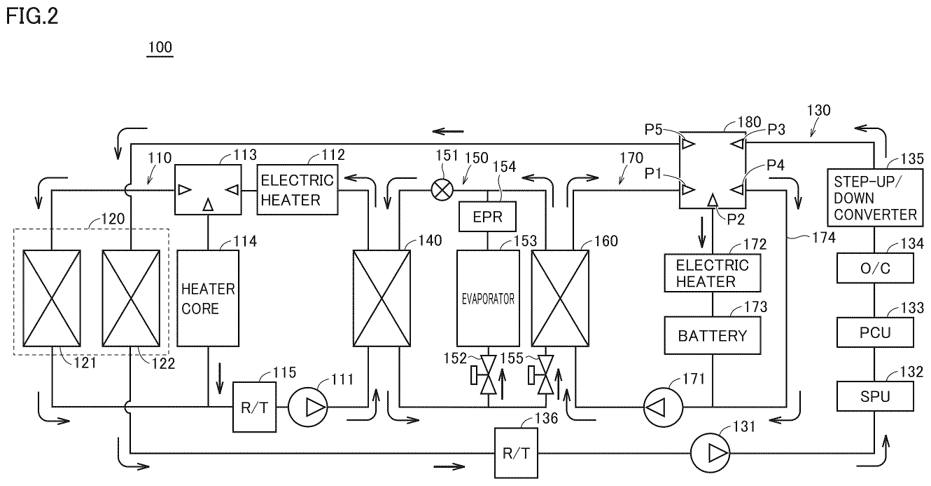

HT circuit 110 includes, for example, a water pump (W/P) 111, an electric heater 112, a three-way valve 113, a heater core 114, and a reservoir tank (R/T) 115. Radiator 120 is connected to (i.e., shared by) both HT circuit 110 and LT circuit 130. Radiator 120 includes a HT radiator 121 and a LT radiator 122 (see FIG. 2 for both). LT circuit 130 includes, for example, a water pump 131, a smart power unit (SPU) 132, a power control unit (PCU) 133, an oil cooler (O/C) 134, a step-up/down converter 135, and a reservoir tank 136. Condenser 140 is connected to both HT circuit 110 and refrigeration cycle 150. Refrigeration cycle 150 includes, for example, a compressor 151, an expansion valve 152, an evaporator 153, an evaporative pressure regulator (EPR) 154, and an expansion valve 155. Chiller 160 is connected to both refrigeration cycle 150 and battery circuit 170. Battery circuit 170 includes, for example, a water pump 171, an electric heater 172, a battery 173, and a bypass path 174. Five-way valve 180 is connected to LT circuit 130 and battery circuit 170. The configuration of thermal management circuit 100 will be described in detail with reference to FIG. 2.

ECU 500 controls thermal management circuit 100. ECU 500 includes a processor 501, a memory 502, a storage 503, and an interface 504.

Processor 501 is, for example, a CPU (Central Processing Unit) or an MPU (Micro-Processing Unit). Memory 502 is, for example, a RAM (Random Access Memory). Storage 503 is a rewritable nonvolatile memory such as an HDD (Hard Disk Drive), an SSD (Solid State Drive), or a flash memory. Storage 503 stores: a system program including an OS (Operating System); and a control program including a computer-readable code necessary for control calculation. Processor 501 reads out the system program and the control program, loads them on memory 502, and executes them, thereby realizing various processes. Interface 504 controls communication between ECU 500 and a component of thermal management circuit 100.

ECU 500 generates a control command based on sensor values (for example, temperatures at various locations) acquired from various sensors (not shown) included in thermal management circuit 100, a user operation received by HMI 600, or the like, and outputs the generated control command to thermal management circuit 100. It should be noted that ECU 500 corresponds to a “controller” according to the present disclosure. ECU 500 may be divided into a plurality of ECUs for respective functions. Although FIG. 1 shows an example in which ECU 500 includes one processor 501, ECU 500 may include a plurality of processors. The same applies to each of memory 502 and storage 503.

In the present specification, the “processor” is not limited to a processor in narrow sense, i.e., a processor that performs a process in a stored-program manner, and can include a hard-wired circuit such as an ASIC (Application Specific Integrated Circuit) or an FPGA (Field-Programmable Gate Array). Thus, the term “processor” may be read as a processing circuitry in which a process is defined in advance by a computer-readable code and/or a hardwired circuit.

HMI 600 is a display including a touch panel, an operation panel, a console, or the like. HMI 600 receives a user operation for controlling thermal management system 1. HMI 600 outputs a signal indicating the user operation to ECU 500.

<Configuration of Thermal Management Circuit>

FIG. 2 is a diagram showing an exemplary configuration of thermal management circuit 100 according to the first embodiment. A heat medium (normally, warm water) circulating in HT circuit 110 flows in one or both of the following paths: a first path through water pump 111, condenser 140, electric heater 112, three-way valve 113, heater core 114, reservoir tank 115, and water pump 111; and a second path through water pump 111, condenser 140, electric heater 112, three-way valve 113, HT radiator 121, reservoir tank 115, and water pump 111.

Water pump 111 circulates the heat medium in HT circuit 110 in accordance with a control command from ECU 500. Condenser 140 receives heat emitted from the heat medium circulating in refrigeration cycle 150, and accordingly heats the heat medium circulating in HT circuit 110. Electric heater 112 heats the heat medium in accordance with a control command from ECU 500. Three-way valve 113 switches between the first path and the second path in accordance with a control command from ECU 500. By heat exchange between the heat medium circulating in HT circuit 110 and air blown into the vehicle compartment, heater core 114 heats the air (heating operation). Reservoir tank 115 stores part of the heat medium in HT circuit 110 (heat medium having overflowed due to increased pressure) so as to maintain pressure and amount of the heat medium in HT circuit 110. HT radiator 121 is disposed on a downstream with respect to a grille shutter (not shown) and performs heat exchange between air outside the vehicle and the heat medium.

The heat medium (cooling liquid) circulating in LT circuit 130 flows in a path through water pump 131, SPU 132, PCU 133, oil cooler 134, step-up/down converter 135, five-way valve 180, LT radiator 122, reservoir tank 136, and water pump 131.

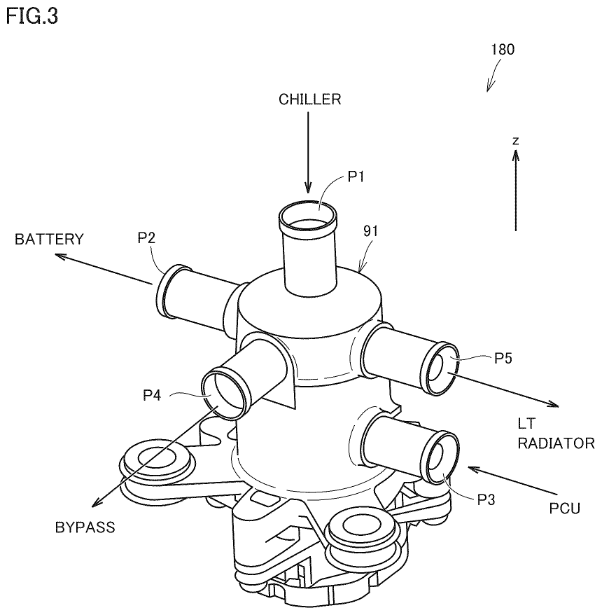

Water pump 131 circulates the heat medium in LT circuit 130 in accordance with a control command from ECU 500. SPU 132 controls charging/discharging of battery 173 in accordance with a control command from ECU 500. PCU 133 converts DC power supplied from battery 173 into AC power in accordance with a control command from ECU 500, and supplies the AC power to a motor (not shown) included in a transaxle. Oil cooler 134 circulates lubricating oil of the motor using an electrical oil pump (EOP) (not shown). Oil cooler 134 cools the transaxle by heat exchange between the heat medium circulating in LT circuit 130 and the lubricating oil of the motor. Step-up/down converter 135 steps up/steps down the voltage of battery 173 in accordance with a control command from ECU 500. SPU 132, PCU 133, oil cooler 134, and step-up/down converter 135 are cooled by the heat medium circulating in LT circuit 130. Five-way valve 180 switches a path for the heat medium in each of LT circuit 130 and battery circuit 170 in accordance with a control command from ECU 500. The configuration of five-way valve 180 will be described in detail with reference to FIGS. 3 to 6. LT radiator 122 is disposed in the vicinity of HT radiator 121 and performs heat exchange with HT radiator 121. Reservoir tank 136 stores part of the heat medium in LT circuit 130 so as to maintain pressure and amount of the heat medium in LT circuit 130.

The heat medium (gas-phase refrigerant or liquid-phase refrigerant) circulating in refrigeration cycle 150 flows in one or both of the following paths: a first path through compressor 151, condenser 140, expansion valve 152, evaporator 153, EPR 154, and compressor 151; and a second path through compressor 151, condenser 140, expansion valve 155, chiller 160, and compressor 151.

Compressor 151 compresses the gas-phase refrigerant circulating in refrigeration cycle 150. Condenser 140 condenses the gas-phase refrigerant into a liquid-phase refrigerant by radiating heat from the gas-phase refrigerant compressed by compressor 151 to have high temperature and high pressure. Expansion valve 152 expands the high-pressure liquid-phase refrigerant compressed by condenser 140, thereby decompressing the liquid-phase refrigerant. Evaporator 153 performs heat exchange between air blown to evaporator 153 and the liquid-phase refrigerant, thereby cooling the air (cooling operation). EPR 154 controls a flow rate of the heat medium flowing from evaporator 153, thereby adjusting the pressure in evaporator 153 to be substantially constant. As with expansion valve 152, expansion valve 155 expands the high-pressure liquid-phase refrigerant compressed by condenser 140, thereby decompressing the liquid-phase refrigerant. Chiller 160 performs heat exchange between the heat medium circulating in refrigeration cycle 150 and the heat medium circulating in battery circuit 170. More specifically, the liquid-phase refrigerant decompressed by expansion valve 155 is evaporated in chiller 160, thereby removing heat from the heat medium circulating in battery circuit 170. Thus, the heat medium circulating in battery circuit 170 is cooled.

The heat medium (cooling liquid) circulating in battery circuit 170 flows in one or both of the following paths: a first path through water pump 171, chiller 160, five-way valve 180, electric heater 172, battery 173, and water pump 171; and a second path through water pump 171, chiller 160, five-way valve 180, bypass path 174, and water pump 171.

Water pump 171 circulates the heat medium in battery circuit 170 in accordance with a control command from ECU 500. Chiller 160 cools the heat medium circulating in battery circuit 170 by heat exchange between the heat medium circulating in refrigeration cycle 150 and the heat medium circulating in battery circuit 170. Electric heater 172 heats the heat medium in accordance with a control command from ECU 500. Battery 173 supplies driving electric power to the motor included in the transaxle. Battery 173 may be heated using electric heater 172 or cooled using chiller 160. Bypass path 174 is provided to allow the heat medium to bypass electric heater 172 and battery 173. When the heat medium flows in bypass path 174, a temperature change of the heat medium due to heat absorption/heat radiation between the heat medium and battery 173 can be suppressed.

It should be noted that in the first embodiment, LT circuit 130 corresponds to the “first circuit” according to the present disclosure. Battery circuit 170 corresponds to the “second circuit” according to the present disclosure. Bypass path 174 corresponds to the “third circuit” according to the present disclosure.

<Five-Way Valve>

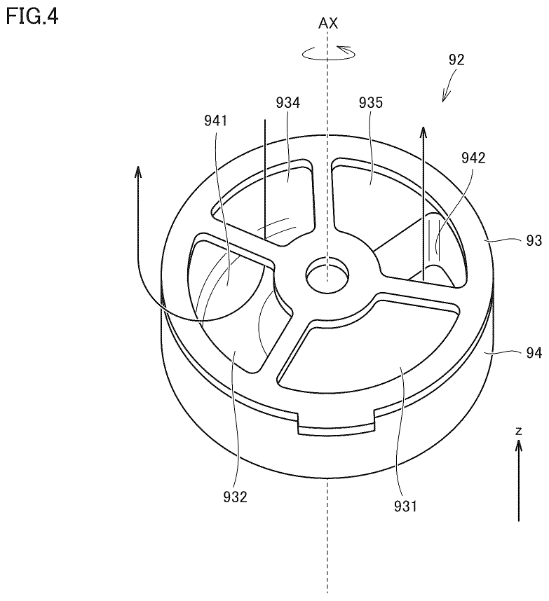

FIG. 3 is a perspective view showing an exemplary external appearance configuration of five-way valve 180. Five-way valve 180 includes a case main body 91. Case main body 91 has a hollow circular column shape (cylindrical shape) extending in the vertical direction, and accommodates valve body 92 (see FIG. 4). Case main body 91 is provided with five ports P1 to P5.

Port P1 is an inlet port via which the heat medium flows from chiller 160. Port P2 is an outlet port via which the heat medium flows out toward electric heater 172 and battery 173 of battery circuit 170 (representatively, battery 173 is shown). Port P3 is an inlet port via which the heat medium flows from SPU 132, PCU 133, oil cooler 134, and step-up/down converter 135 of LT circuit 130 (representatively, PCU 133 is shown). Port P4 is an outlet port via which the heat medium flows out toward bypass path 174 of battery circuit 170. Port P5 is an outlet port via which the heat medium flows out toward LT radiator 122.

Ports P1, P2, P4, P5 are disposed at an upper portion of case main body 91. On the other hand, port P3 is disposed at a lower portion of case main body 91.

FIG. 4 is a perspective view showing an exemplary configuration of valve body 92. Valve body 92 has a circular column shape extending in the vertical direction, and is configured to rotate around the central axis of the circular column. This central axis will be described as a rotation axis AX. Valve body 92 includes a fixation portion 93 having a disc shape and a driving portion 94 having a circular column shape. Driving portion 94 is driven to rotate around rotation axis AX, whereas fixation portion 93 is always fixed while ensuring slidability between driving portion 94 and fixation portion 93.

Fixation portion 93 is provided with four holes 931, 932, 934, 935 each having a shape of fan. Four holes 931, 932, 934, 935 respectively correspond to four ports P1, P2, P4, P5 disposed at the upper portion of case main body 91. Driving portion 94 is provided with: a circumferential groove 941 extending in a circumferential direction of the circular column; and a longitudinal through hole 942 extending in a height direction of the circular column.

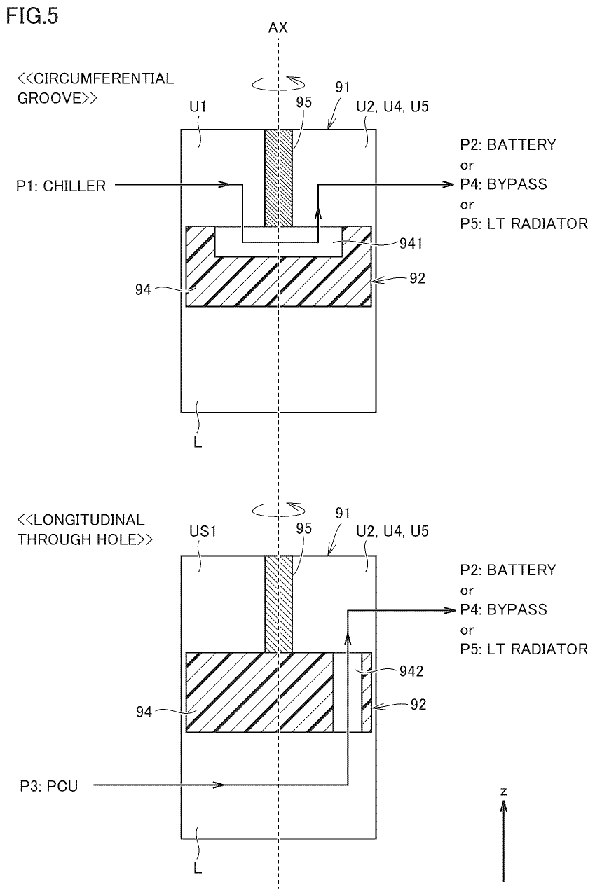

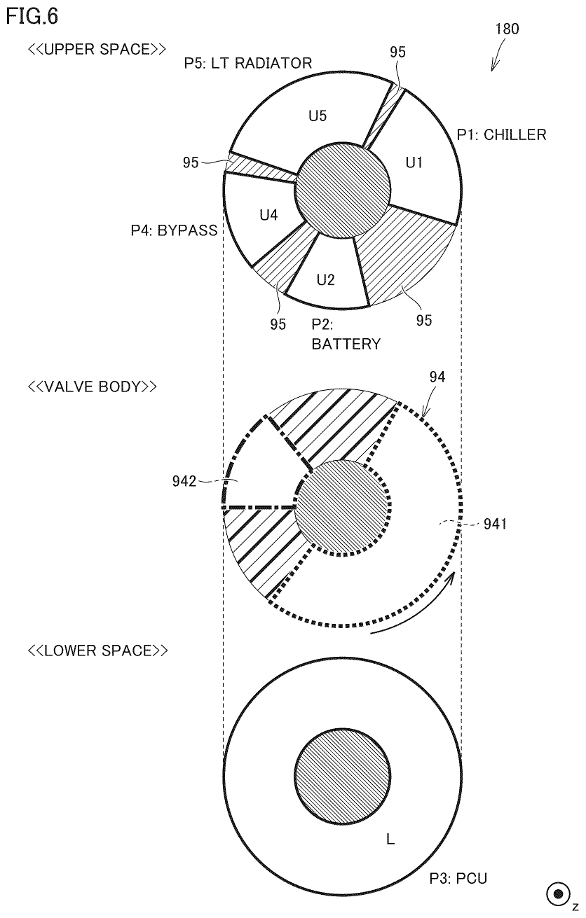

FIG. 5 is a first diagram for illustrating a manner of flow of the heat medium inside five-way valve 180 according to the first embodiment. FIG. 5 schematically shows a cross sectional view of case main body 91 and valve body 92 along a plane including rotation axis AX. FIG. 6 is a second diagram for illustrating a manner of flow of the heat medium inside five-way valve 180. FIG. 6 schematically shows a positional relation among a space above valve body 92, valve body 92, and a space below valve body 92 in an internal space of case main body 91.

Referring to FIGS. 4 to 6, the space above valve body 92 is partitioned into four spaces by four partition walls 95. These spaces will be described as upper spaces U1, U2, U4, U5. Upper space U1 is a space above hole 931 provided in fixation portion 93 and communicates with port P1. Upper space U2 is a space above hole 932 of fixation portion 93 and communicates with port P2. Upper space U4 is a space above hole 934 of fixation portion 93 and communicates with port P4. Upper space U5 is a space above hole 935 of fixation portion 93 and communicates with port P5. On the other hand, no partition wall is provided in the space below valve body 92 in the inner space of case main body 91. This space will be described as a lower space L. Lower space L communicates with port P3.

As valve body 92 is driven to rotate, the positions of circumferential groove 941 and longitudinal through hole 942 provided in driving portion 94 are changed. Thus, two (or three) of upper spaces U1, U2, U4, U5 communicate with each other via circumferential groove 941, or one (or two) of upper spaces U1, U2, U4, U5 communicates with lower space L via longitudinal through hole 942. Thus, connections of ports P1 to P5 are switched.

For example, when upper space U1 and upper space U2 communicate with each other via circumferential groove 941, the heat medium can flow from port P1 to port P2. When upper space U1 communicates with upper space U4 via circumferential groove 941, the heat medium can flow from port P1 toward port P4. When upper space U1 communicates with upper space U5 via circumferential groove 941, the heat medium can flow from port P1 toward port P5.

On the other hand, when lower space L and upper space U2 communicate with each other via longitudinal through hole 942, the heat medium can flow from port P3 toward port P2. When lower space L and upper space U4 communicate with each other via longitudinal through hole 942, the heat medium can flow from port P3 toward port P4. When lower space L and upper space U5 communicate with each other via longitudinal through hole 942, the heat medium can flow from port P3 toward port P5.

It should be noted that each of upper spaces U1, U2, U4, U5 corresponds to a “first space” according to the present disclosure. Lower space L corresponds to a “second space” according to the present disclosure. Circumferential groove 941 corresponds to a “first communication portion” according to the present disclosure. Longitudinal through hole 942 corresponds to a “second communication portion” according to the present disclosure.

In the present embodiment, four “communication patterns” are realized using five-way valve 180 configured as described above. These will be described as first to fourth communication patterns.

<Communication Patterns>

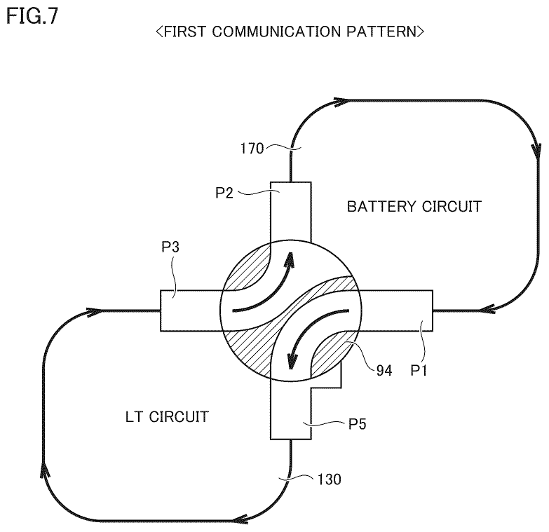

FIGS. 7 to 10 are conceptual diagrams showing overviews of the first to fourth communication patterns by five-way valve 180. As shown in FIG. 7, in the first communication pattern, a path that communicates port P1 and port P5 with each other and a path that communicates port P3 and port P2 with each other are formed by five-way valve 180. In this case, LT circuit 130 and battery circuit 170 are connected together in series.

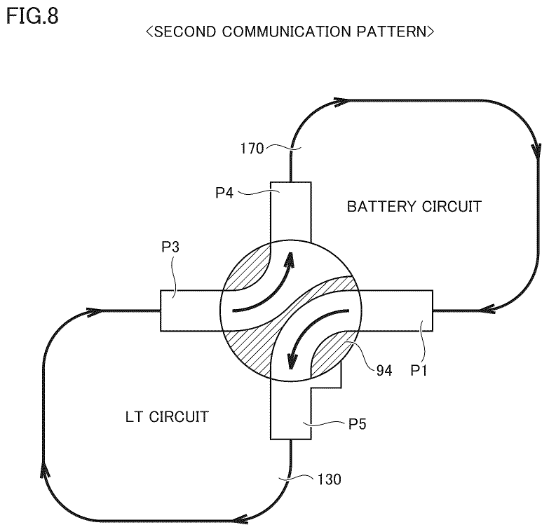

In the second communication pattern (see FIG. 8), a path that communicates port P1 and port P5 with each other and a path that communicates port P3 and port P4 with each other are formed by five-way valve 180. Also in this case, LT circuit 130 and battery circuit 170 are connected together in series.

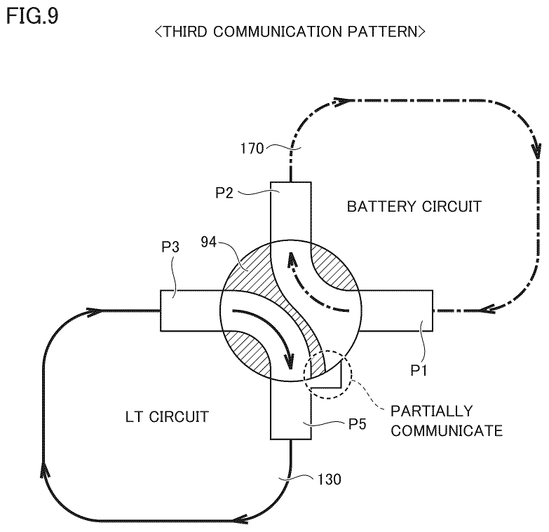

In the third communication pattern (see FIG. 9), a path that communicates port P1 and port P2 with each other and a path that communicates port P3 and port P5 with each other are formed by five-way valve 180. In addition to these two paths, a narrow path that connects between the two paths is formed. Thus, LT circuit 130 and battery circuit 170 partially communicate with each other while LT circuit 130 and battery circuit 170 are substantially connected together in parallel.

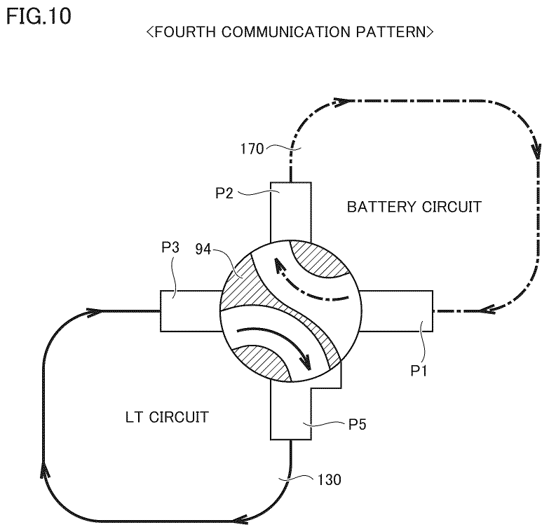

In the fourth communication pattern (see FIG. 10), a path that communicates port P1 and port P2 with each other and a path that communicates port P3 and port P5 with each other are formed by five-way valve 180. These two paths are independent of each other, and no other path that connects between the two paths is formed. In this case, LT circuit 130 and battery circuit 170 are connected together in parallel completely independently.

<Circuit Modes>

In each of the first communication pattern to the fourth communication pattern by five-way valve 180, various “circuit modes” are realized depending on a manner of operation of a component other than five-way valve 180 (such as on/off of the water pump).

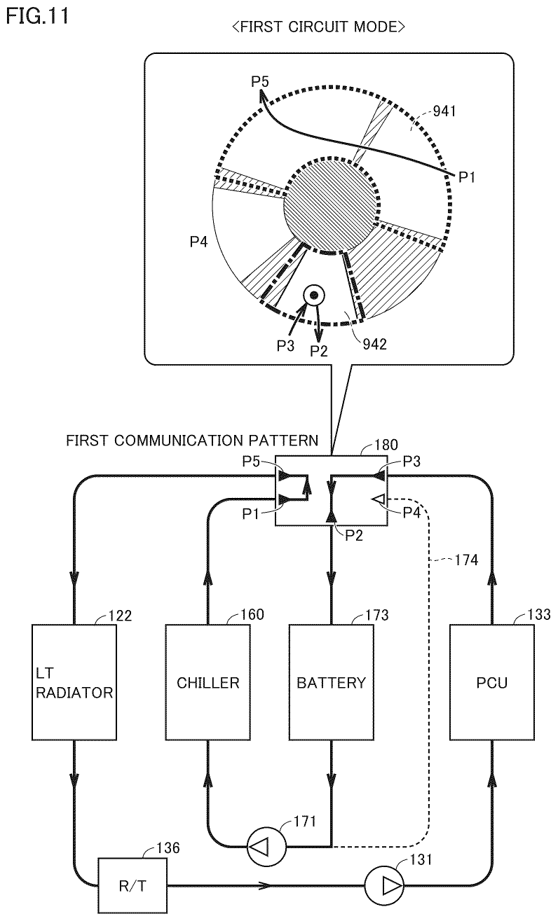

A representative circuit mode in each of the first to fourth communication patterns will be described with reference to FIGS. 11 to 14. At a lower portion of each of FIGS. 11 to 14, a manner of flow of the heat medium in the whole of thermal management circuit 100 is shown. However, here, in order to avoid the figures from being complicated, only main components of the components of thermal management circuit 100 shown in FIG. 2 are shown. On the other hand, at the upper portion of each of FIGS. 11 to 14, a manner of flow of the heat medium inside five-way valve 180 is shown. In each of these figures, three diagrams showing the upper space, the valve body, and the lower space shown in FIG. 6 are shown to overlap while they are illustrated in a simplified manner.

It should be noted that the first circuit mode corresponds to a “first mode” according to the present disclosure. The third circuit mode corresponds to a “second mode” according to the present disclosure. The fourth circuit mode corresponds to a “third mode” according to the present disclosure. The second circuit mode corresponds to a “fourth mode” according to the present disclosure.

FIG. 11 is a diagram for illustrating the first circuit mode according to the first embodiment. In the first circuit mode, five-way valve 180 is set to the first communication pattern (see FIG. 7). As shown in the upper view of FIG. 11, upper space U1 and upper space U5 of five-way valve 180 communicate with each other via circumferential groove 941 (see a broken line), with the result that port P1 and port P5 communicate with each other. Further, lower space L and upper space U2 of five-way valve 180 communicate with each other via longitudinal through hole 942 (see an alternate long and short dash line), with the result that port P3 and port P2 communicate with each other. Thus, as shown in the lower diagram of FIG. 11, LT circuit 130 and battery circuit 170 are connected together in series. More specifically, one path is formed in which the heat medium flows in the order of water pump 131, PCU 133, port P3, port P2, battery 173, water pump 171, chiller 160, port P1, port P5, LT radiator 122, reservoir tank 136, and water pump 131.

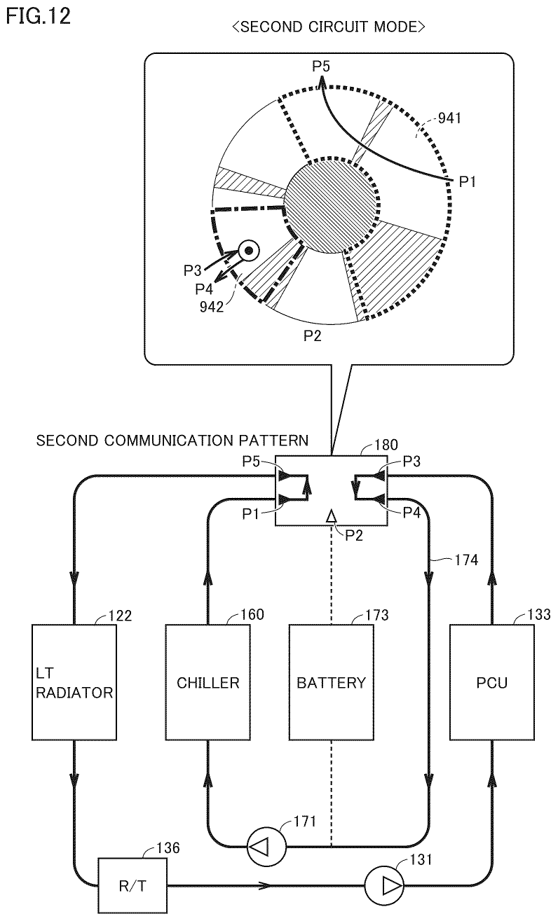

FIG. 12 is a diagram for illustrating the second circuit mode according to the first embodiment. In the second circuit mode, five-way valve 180 is set to the second communication pattern (see FIG. 8). Upper space U1 and upper space U5 of five-way valve 180 communicate with each other via circumferential groove 941, with the result that port P1 and port P5 communicate with each other. Further, lower space L and upper space U4 of five-way valve 180 communicate with each other via longitudinal through hole 942, with the result that port P3 and port P4 communicate with each other. Thus, LT circuit 130 and battery circuit 170 are connected together in series. More specifically, one path is formed in which the heat medium flows in the order of water pump 131, PCU 133, port P3, port P4, bypass path 174, water pump 171, chiller 160, port P1, port P5, LT radiator 122, reservoir tank 136, and water pump 131.

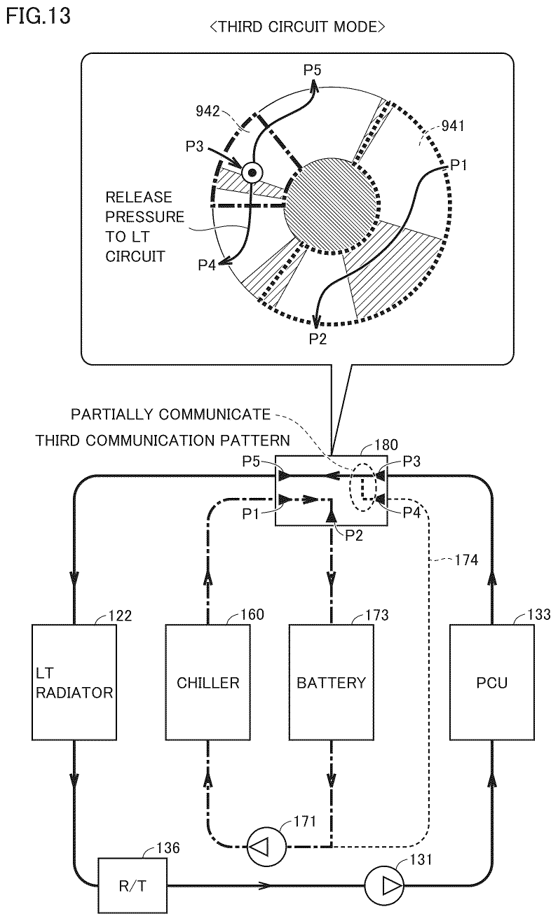

FIG. 13 is a diagram for illustrating the third circuit mode according to the first embodiment. In the third circuit mode, five-way valve 180 is set to the third communication pattern (see FIG. 9). Upper space U1 and upper space U2 of five-way valve 180 communicate with each other via circumferential groove 941, with the result that port P1 and port P2 communicate with each other. Further, lower space L and upper space U5 of five-way valve 180 communicate with each other via longitudinal through hole 942, with the result that port P3 and port P5 communicate with each other. Thus, LT circuit 130 and battery circuit 170 are connected together in parallel. More specifically, the following paths are formed: a first path (LT circuit 130) in which the heat medium flows in the order of water pump 131, PCU 133, port P3, port P5, LT radiator 122, and reservoir tank 136; and a second path (battery circuit 170) in which the heat medium flows in the order of water pump 171, chiller 160, port P1, port P2, battery 173, and water pump 171. In addition, in the third circuit mode, lower space L and upper space U5 of five-way valve 180 communicate with each other via longitudinal through hole 942, with the result that port P3 and port P4 partially communicate with each other.

Determining which two ports to partially communicate with each other (where to set the partial communication position) affects a pressure distribution of the heat medium in thermal management circuit 100 (particularly, battery circuit 170). An inappropriate partial communication position may adversely affect a normal operation of battery circuit 170. More specifically, an excessive pressure may be applied to any component of battery circuit 170 while each component thereof has the maximum pressure (withstanding pressure) that can be applied thereto. Further, when the pressure at any location of battery circuit 170 (particularly, the pressure at the inlet of water pump 171) becomes a negative pressure, air bubbles (cavitation) may be generated in the heat medium. Therefore, in battery circuit 170, it is desirable to set the partial communication position so as to avoid each component from being fed with a pressure exceeding the withstanding pressure and so as to avoid generation of the cavitation.

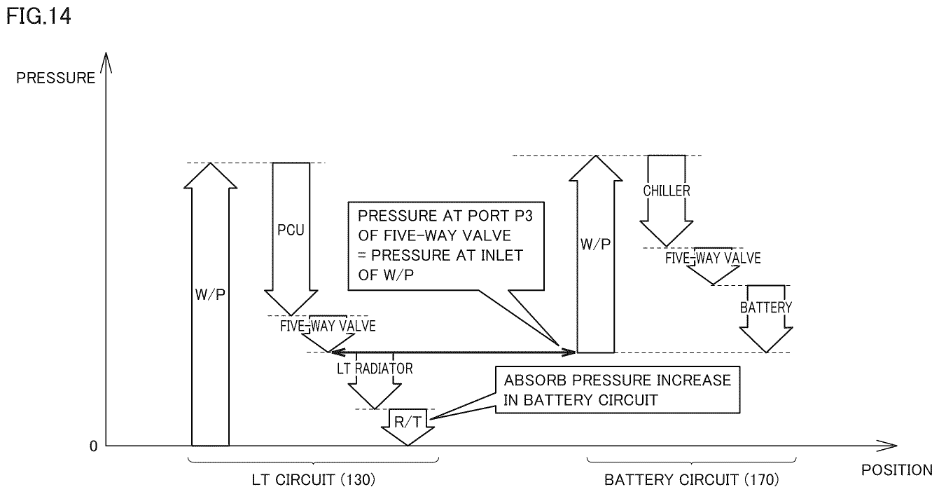

FIG. 14 is a diagram for illustrating a pressure distribution of the heat medium in the fourth circuit mode according to the first embodiment. The horizontal axis represents an arrangement of the components of thermal management circuit 100 along the path in which the heat medium flows. The vertical axis represents the pressure of the heat medium in each component.

In the present embodiment, when port P3 and port P4 partially communicate with each other, the pressure of the heat medium in battery circuit 170 can be released to LT circuit 130. Since LT circuit 130 is provided with reservoir tank 136, reservoir tank 136 of LT circuit 130 can absorb pressure increase of the heat medium caused by a temperature change of the heat medium circulating in battery circuit 170. Therefore, pressure applied to each component of battery circuit 170 can be suppressed to be less than the withstanding pressure.

Further, when port P3 and port P4 partially communicate with each other, the pressure of the heat medium at five-way valve 180 (port P3) in LT circuit 130 and the pressure of the heat medium at the inlet of water pump 171 of battery circuit 170 become equal to each other. Since the pressure of five-way valve 180 in LT circuit 130 is always a positive pressure, the pressure at the inlet of water pump 171 is also a positive pressure. Therefore, generation of cavitation in battery circuit 170 can be suppressed.

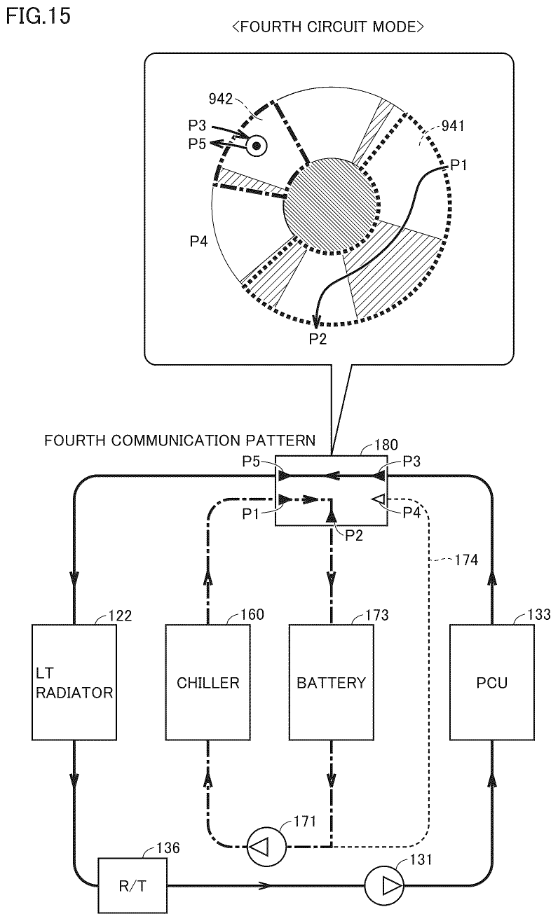

FIG. 15 is a diagram for illustrating the fourth circuit mode according to the first embodiment. In the fourth circuit mode, five-way valve 180 is set to the fourth communication pattern (see FIG. 10). Upper space U1 and upper space U2 of five-way valve 180 communicate with each other via circumferential groove 941, with the result that port P1 and port P2 communicate with each other. Further, lower space L and upper space U5 of five-way valve 180 communicate with each other via longitudinal through hole 942, with the result that port P3 and port P5 communicate with each other. Thus, LT circuit 130 and battery circuit 170 are connected together in parallel completely independently. More specifically, the following paths are formed: a first path (LT circuit 130) in which the heat medium flows in the order of water pump 131, PCU 133, port P3, port P5, LT radiator 122, reservoir tank 136, and water pump 131; and a second path (battery circuit 170) in which the heat medium flows in the order of water pump 171, chiller 160, port P1, port P2, battery 173, and water pump 171.

As described above, thermal management system 1 according to the first embodiment includes five-way valve 180 configured to realize the third communication pattern (see FIG. 9). In the third circuit mode (see FIG. 13) to which the third communication pattern is applied, the narrow path (partial communication path between port P3 and port P4) that connects between LT circuit 130 and battery circuit 170 connected together in parallel is formed between the two circuits. Via this narrow path, the pressure of the heat medium flowing in battery circuit 170 is released to LT circuit 130, with the result that the pressure increase of battery circuit 170 can be absorbed by reservoir tank 136 provided in LT circuit 130. Therefore, according to the first embodiment, even when battery circuit 170 is not provided with the reservoir tank, a trouble due to expansion of the heat medium can be prevented.

### Modification of First Embodiment

In a modification of the first embodiment, it will be illustratively described that the five-way valve has a configuration different from that of valve body 92 (see FIG. 6) of the first embodiment. However, the basic structure of the five-way valve in the present modification is the same as the structure described with reference to FIGS. 3 to 5, and therefore will not be described repeatedly.

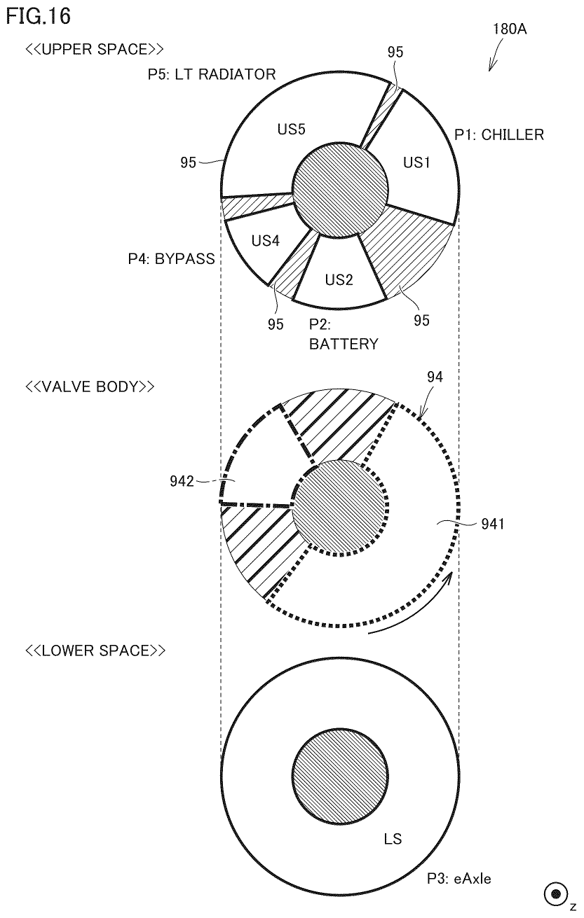

FIG. 16 is a second diagram for illustrating a manner of flow of the heat medium inside a five-way valve 180A according to the modification of the first embodiment. FIG. 16 is compared with FIG. 6. It is understood that five-way valve 180A according to the modification of the first embodiment has upper spaces U1, U2, U4, U5 different from those of five-way valve 180 according to the first embodiment in terms of sizes, shapes or arrangement in the circumferential direction.

It should be noted that in this example, the structure of valve body 92 is the same. However, the structure of the valve body (more specifically, the arrangement of circumferential groove 941 and longitudinal through hole 942 or the like) may be different. When each of the upper spaces is the same but the structure of the valve body is different, the manner of flow of the heat medium can be different. Therefore, at least one of the upper space and the structure of the valve body may be different.

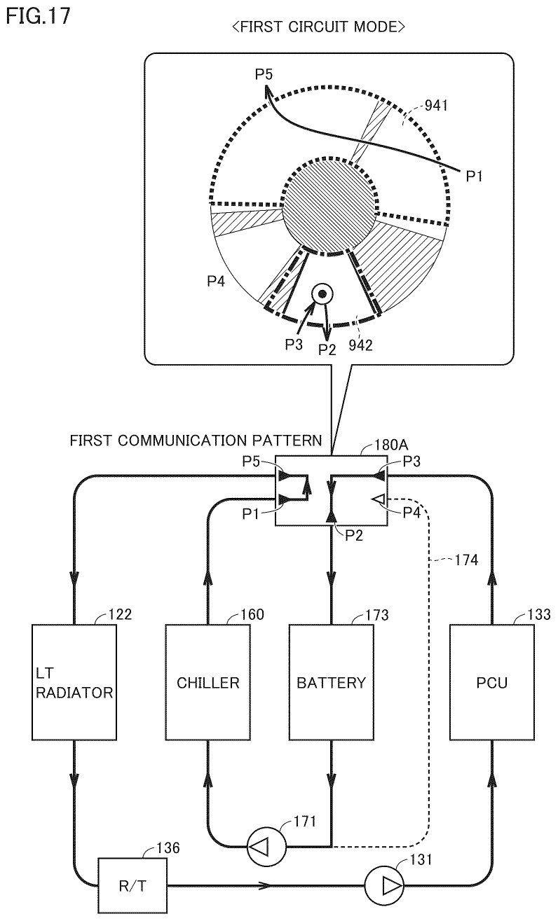

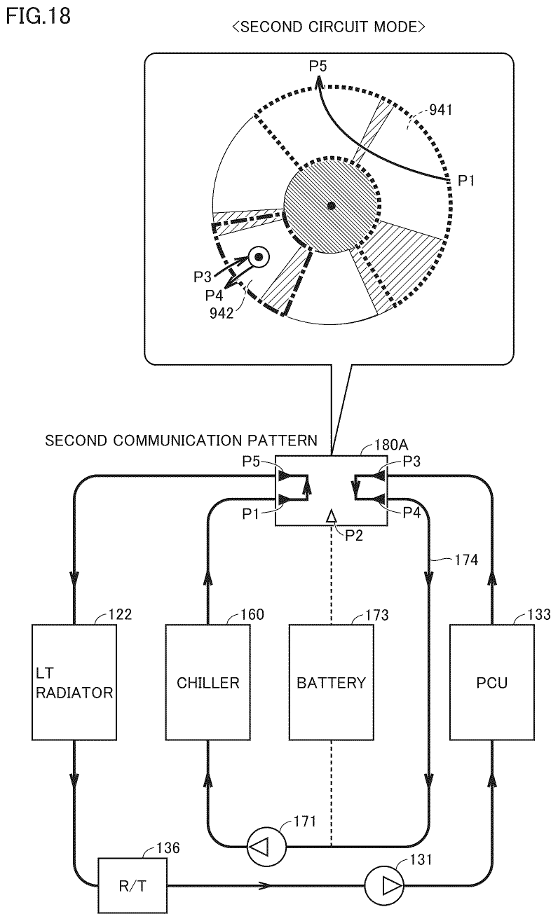

FIG. 17 is a diagram for illustrating a first circuit mode according to the modification of the first embodiment. FIG. 18 is a diagram for illustrating a second circuit mode according to the modification of the first embodiment. FIG. 17 is compared with FIG. 11, and FIG. 18 is compared with FIG. 12. The first circuit mode and the second circuit mode are the same between the first embodiment and the modification thereof.

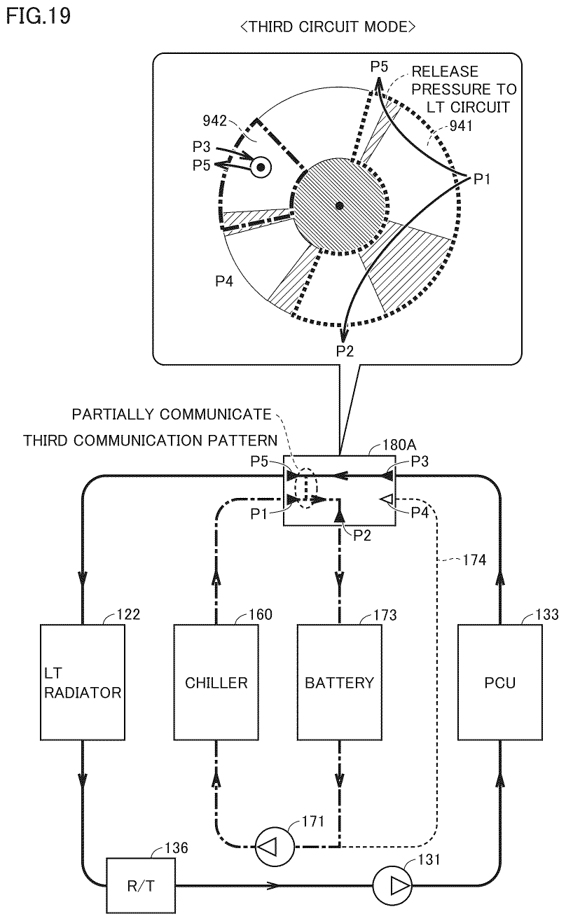

FIG. 19 is a diagram for illustrating a third circuit mode according to the modification of the first embodiment. FIG. 19 is compared with FIG. 13. Also in the present modification, five-way valve 180 in the third circuit mode is set to the third communication pattern (see FIG. 9). Upper space U1 and upper space U2 of five-way valve 180 communicate with each other via circumferential groove 941, with the result that port P1 and port P2 communicate with each other. Further, lower space L of five-way valve 180 and upper space U5 of five-way valve 180 communicate with each other via longitudinal through hole 942, with the result that port P3 and port P5 communicate with each other. Thus, LT circuit 130 and battery circuit 170 are connected together in parallel. This parallel connection is the same as that in the first embodiment.

In the first embodiment, lower space L and upper space U5 of five-way valve 180 communicate with each other via longitudinal through hole 942, with the result that port P3 and port P4 partially communicate with each other (see FIG. 13). On the other hand, the present modification is different from the first embodiment in the following point: upper space U1 and upper space U5 of five-way valve 180A communicate with each other via circumferential groove 941, with the result that port P1 and port P5 partially communicate with each other.

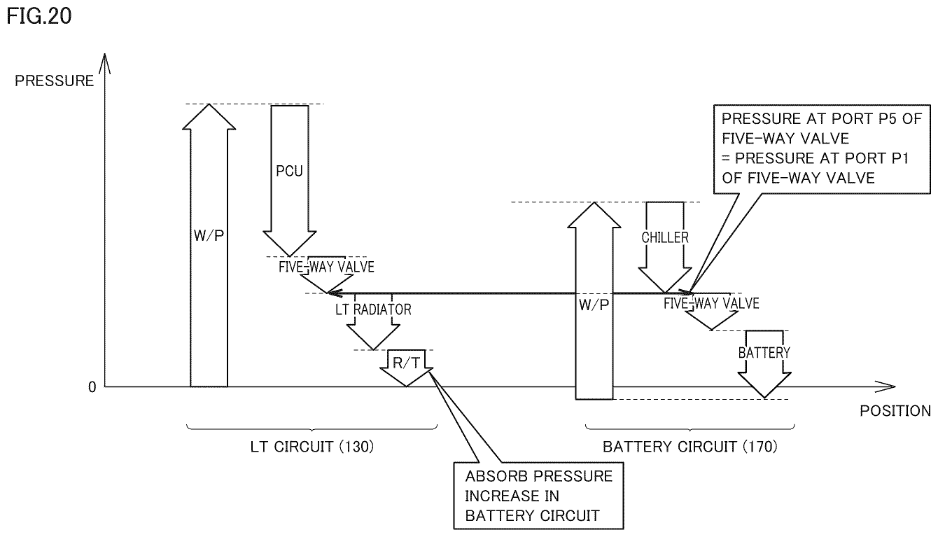

FIG. 20 is a diagram for illustrating a pressure distribution of the heat medium in the third circuit mode according to the modification of the first embodiment. With the communication as shown in FIG. 19, the pressure at port P5 of five-way valve 180A in LT circuit 130 becomes equal to the pressure at port P1 of five-way valve 180A in battery circuit 170. Thus, the pressure of the heat medium in battery circuit 170 can be released to LT circuit 130. Since LT circuit 130 is provided with reservoir tank 136, reservoir tank 136 can absorb pressure increase of the heat medium caused by a temperature change of the heat medium circulating in battery circuit 170. Therefore, the pressure applied to each component of battery circuit 170 can be suppressed to be less than the withstanding pressure.

In the first embodiment, generation of cavitation in battery circuit 170 can be suppressed (see FIG. 14). On the other hand, in the present modification, depending on a relation between an amount of pressure increase by water pump 171 and an amount of pressure decrease in battery 173, the pressure between battery 173 and water pump 171 may become a negative pressure as shown in FIG. 20. That is, possibility of generation of cavitation between battery 173 and water pump 171 cannot be denied in principle. However, the third circuit mode as in the present modification can also be employed as long as the amount of pressure increase by water pump 171 is sufficiently large or the amount of pressure decrease in battery 173 is sufficiently small and generation of negative pressure can be suppressed under normal use conditions.

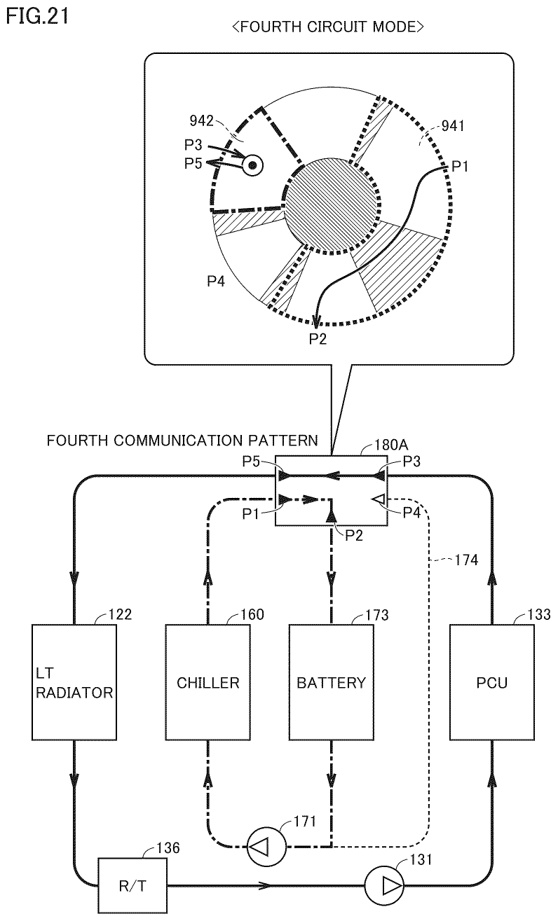

FIG. 21 is a diagram for illustrating the fourth circuit mode according to the modification of the first embodiment. FIG. 21 is compared with FIG. 15. The fourth circuit mode is the same between the first embodiment and the modification thereof.

As described above, also in the modification of the first embodiment, as with the first embodiment, five-way valve 180A is configured to form the third communication pattern (see FIG. 9). In the third communication pattern, the narrow path that connects between LT circuit 130 and battery circuit 170 connected together in parallel is formed between the two circuits. Via this narrow path, the pressure of the heat medium in battery circuit 170 is released to LT circuit 130, with the result that the pressure increase of the heat medium in battery circuit 170 can be absorbed by reservoir tank 136 provided in LT circuit 130 (see FIG. 19). Therefore, according to the modification of the first embodiment, a trouble due to expansion of the heat medium can be prevented even when battery circuit 170 is not provided with the reservoir tank.

It should be noted that also in the modification of the first embodiment, as with the first embodiment, LT circuit 130 corresponds to the “first circuit” according to the present disclosure. Battery circuit 170 corresponds to the “second circuit” according to the present disclosure. Bypass path 174 corresponds to the “third circuit” according to the present disclosure. The first circuit mode corresponds to the “first mode” according to the present disclosure. The third circuit mode corresponds to the “second mode” according to the present disclosure. The fourth circuit mode corresponds to the “third mode” according to the present disclosure. The second circuit mode corresponds to the “fourth mode” according to the present disclosure.

### Second Embodiment

In each of the first embodiment and the modification, it has been illustratively described that five-way valve 180, 180A is employed. However, the configuration of the multi-way valve according to the present disclosure is not limited thereto. In a second embodiment, it will be described that the multi-way valve according to the present disclosure is an eight-way valve.

<Overall Configuration>

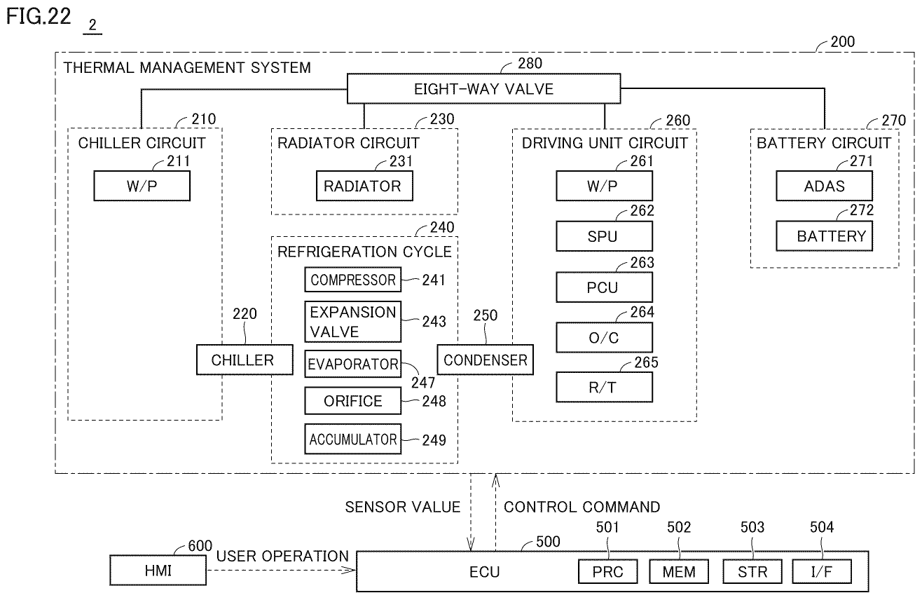

FIG. 22 is a diagram showing an exemplary overall configuration of a thermal management system according to the second embodiment of the present disclosure. A thermal management system 2 is different from thermal management system 1 (see FIG. 1) according to the first embodiment in that thermal management system 2 includes a thermal management circuit 200 instead of thermal management circuit 100.

Thermal management circuit 200 includes, for example, a chiller circuit 210, a chiller 220, a radiator circuit 230, a refrigeration cycle 240, a condenser 250, a driving unit circuit 260, a battery circuit 270, and an eight-way valve 280.

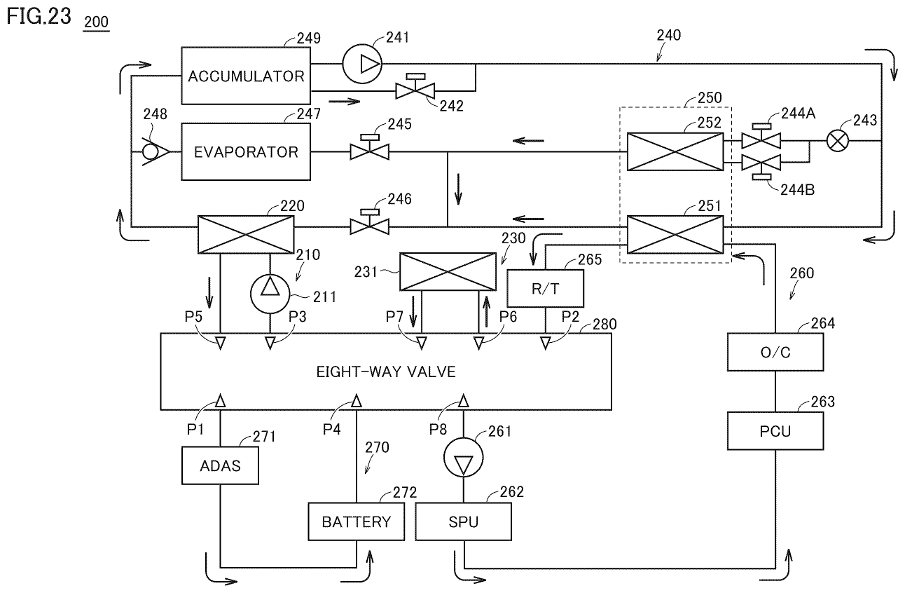

Chiller circuit 210 includes a water pump (W/P) 211. Chiller 220 is connected to (shared by) both chiller circuit 210 and refrigeration cycle 240. Radiator circuit 230 includes a radiator 231. Refrigeration cycle 240 includes, for example, a compressor 241, an electromagnetic valve 242 (see FIG. 23), an expansion valve 243, electromagnetic valves 244A, 244B, 245, 246 (see FIG. 23), an evaporator 247, an orifice (expansion valve) 248, and an accumulator 249. Condenser 250 includes a water-cooled condenser 251 and an air-cooled condenser 252 (see FIG. 23), and is connected to both refrigeration cycle 240 and driving unit circuit 260. Driving unit circuit 260 includes, for example, a water pump 261, an SPU 262, a PCU 263, an oil cooler 264 and a reservoir tank 265. Battery circuit 270 includes, for example, an advanced driver-assistance system (ADAS) 271 and a battery 272. Eight-way valve 280 includes ports P1 to P8 (see FIG. 23), and is connected to chiller circuit 210, radiator circuit 230, driving unit circuit 260, and battery circuit 270.

<Configuration of Thermal Management Circuit>

FIG. 23 is a diagram showing an exemplary configuration of thermal management circuit 200 according to the second embodiment. The heat medium circulating in chiller circuit 210 flows in a path through eight-way valve 280 (port P3), water pump 211, chiller 220, and eight-way valve 280 (port P5).

Water pump 211 circulates the heat medium in chiller circuit 210 in accordance with a control command from ECU 500. Chiller 220 performs heat exchange between the heat medium circulating in chiller circuit 210 and the heat medium circulating in refrigeration cycle 220. Eight-way valve 280 switches a path to which chiller circuit 210 is to be connected, in accordance with a control command from ECU 500. The switching of the path by eight-way valve 280 will be described in detail later.

The heat medium circulating in radiator circuit 230 flows between radiator 231 and eight-way valve 280 (ports P6, P7). Radiator 231 is disposed on a downstream with respect to a grille shutter (not shown) and performs heat exchange between air outside the vehicle and the heat medium.

The heat medium (gas-phase refrigerant or liquid-phase refrigerant) circulating in refrigeration cycle 240 flows in one of the following paths: a first path through compressor 241, expansion valve 243, electromagnetic valve 244 (244A, 244B), air-cooled condenser 252, electromagnetic valve 245, evaporator 247, orifice 248, accumulator 249, and compressor 241; a second path through compressor 241, air-cooled condenser 252, electromagnetic valve 246, chiller 220, accumulator 249, compressor 241; and a third path through compressor 241, expansion valve 243, electromagnetic valve 244 (244A, 244B), air-cooled condenser 252, electromagnetic valve 246, chiller 220, accumulator 249, and compressor 241.

Compressor 241 compresses the gas-phase refrigerant circulating in refrigeration cycle 240 in accordance with a control command from ECU 500. Electromagnetic valve 242 is connected to compressor 241 in parallel, and adjusts an amount of the gas-phase refrigerant flowing into compressor 241 in accordance with a control command from ECU 500. Expansion valve 243 expands the high-pressure liquid-phase refrigerant compressed by condenser 241, thereby decompressing the liquid-phase refrigerant. Electromagnetic valve 244 (244A, 244B) switches on/off the flow of the liquid-phase refrigerant between expansion valve 243 and air-cooled condenser 252 in accordance with a control command from ECU 500. Air-cooled condenser 252 performs heat exchange with water-cooled condenser 251 of driving unit circuit 260. Electromagnetic valve 245 restricts the flow of the liquid-phase refrigerant into evaporator 247 in accordance with a control command from ECU 500. Electromagnetic valve 246 restricts the flow of the liquid-phase refrigerant into chiller 220 in accordance with a control command from ECU 500. Orifice 248 decompresses the refrigerant from evaporator 247. Accumulator 249 prevents the liquid-phase refrigerant from being suctioned into compressor 241 when the refrigerant is not completely evaporated by evaporator 247.

The heat medium (cooling liquid) circulating in driving unit circuit 260 flows in a path through eight-way valve 280 (port P8), water pump 261, SPU 262, PCU 263, oil cooler 264, water-cooled condenser 251, reservoir tank 265, and eight-way valve 280 (port P2).

Water pump 261 circulates the heat medium in driving unit circuit 260 in accordance with a control command from ECU 500. SPU 262 controls charging/discharging of battery 272 in accordance with a control command from ECU 500. In accordance with a control command from ECU 500, PCU 263 converts DC power supplied from battery 272 into AC power, and supplies the AC power to the motor (not shown) included in the transaxle. Oil cooler 264 cools the transaxle by heat exchange between the heat medium circulating in driving unit circuit 260 and the lubricating oil of the motor. SPU 262, PCU 263, and oil cooler 264 are cooled by the heat medium circulating in driving unit circuit 260. Water-cooled condenser 251 performs heat exchange with air-cooled condenser 252 of refrigeration cycle 250. Reservoir tank 265 stores part of the heat medium in driving unit circuit 260 (heat medium having overflowed due to increased pressure) so as to maintain pressure and amount of the heat medium in driving unit circuit 260.

The heat medium (cooling liquid) circulating in battery circuit 270 flows in a path through eight-way valve 280 (port P1), ADAS 271, battery 272, and eight-way valve 280 (port P4).

ADAS 271 includes, for example, an adaptive cruise control (ACC), an auto speed limiter (ASL) and a lane keeping assist (LKA), a pre-crash safety (PCS), and a lane departure alert (LDA). Battery circuit 270 may include an autonomous driving system (ADS) in addition to ADAS 271. Battery 272 supplies traveling electric power to the motor included in the transaxle.

<Communication Patterns>

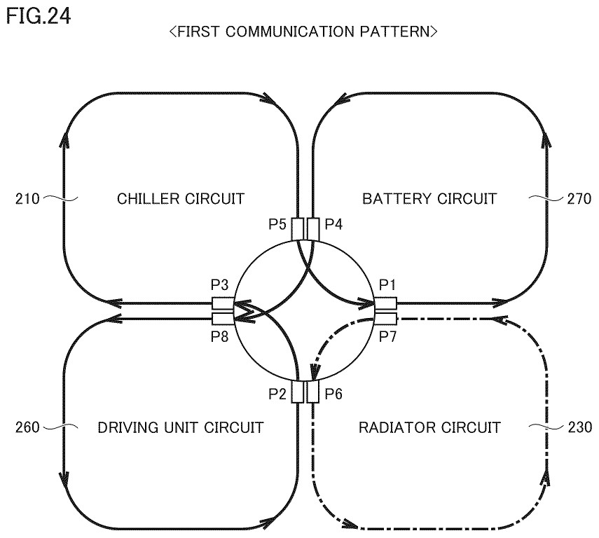

FIGS. 24 to 29 are conceptual diagrams showing overviews of first to sixth communication patterns by eight-way valve 280. In the first communication pattern (see FIG. 24), eight-way valve 280 forms a path that communicates port P5 and port P1 with each other, a path that communicates port P4 and port P8 with each other, a path that communicates port P2 and port P3 with each other, and a path that communicates port P7 and port P6 with each other. Thus, battery circuit 270, driving unit circuit 260, and chiller circuit 210 are connected together in series. Radiator circuit 230 is formed independently of the three circuits connected together in series.

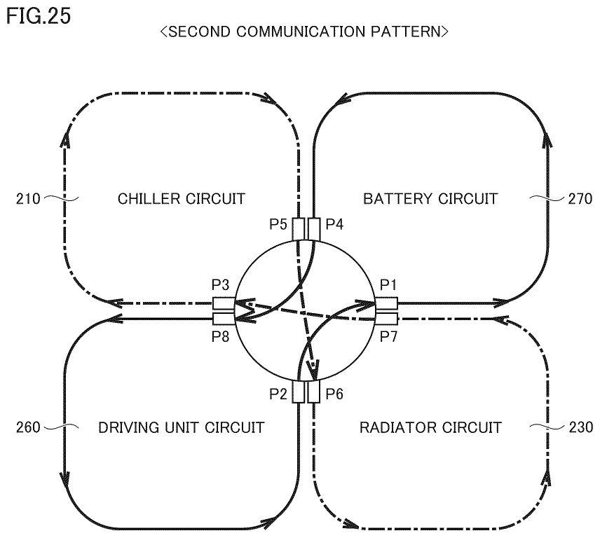

In the second communication pattern (see FIG. 25), eight-way valve 280 forms a path that communicates port P2 and port P1 with each other, a path that communicates port P4 and port P8 with each other, a path that communicates port P5 and port P6 with each other, and a path that communicates port P7 and port P3 with each other. Thus, battery circuit 270 and driving unit circuit 260 are connected together in series, and chiller circuit 210 and radiator circuit 230 are connected together in series.

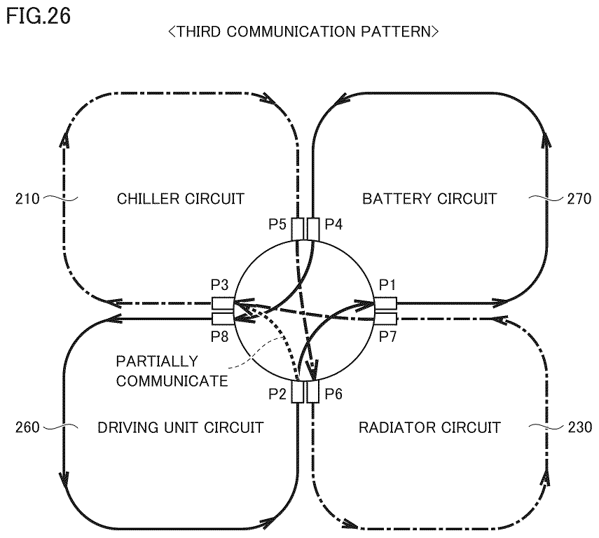

In the third communication pattern (see FIG. 26), as with the second communication pattern, eight-way valve 280 forms a path that communicates port P2 and port P1 with each other, a path that communicates port P4 and port P8 with each other, a path that communicates port P5 and port P6 with each other, and a path that communicates port P7 and port P3 with each other. Thus, battery circuit 270 and driving unit circuit 260 are connected together in series, and chiller circuit 210 and radiator circuit 230 are connected together in series.

In addition, in the third communication pattern, a path that communicates port P2 and port P3 with each other is formed. Accordingly, driving unit circuit 260 and chiller circuit 210 partially communicate with each other. Thus, battery circuit 270 and chiller circuit 210 can partially communicate with each other. This is because driving unit circuit 260 and battery circuit 270 are connected together in series.

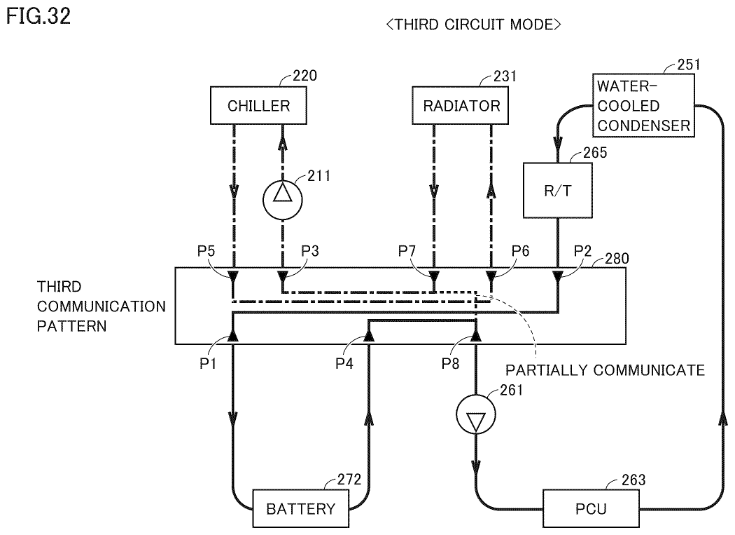

Although not shown here, in the third communication pattern, instead of the path that communicates port P2 and port P3 with each other, a path that communicates port P7 and port P8 with each other may be formed (see FIG. 32). In this case, driving unit circuit 260 and radiator circuit 230 partially communicate with each other, with the result that battery circuit 270 and radiator circuit 230 can partially communicate with each other. The location of communication is not particularly limited as long as the two series-connected circuits (the series-connected circuit constituted of battery circuit 270 and driving unit circuit 260 and the series-connected circuit constituted of chiller circuit 210 and radiator circuit 230) partially communicate with each other in this way.

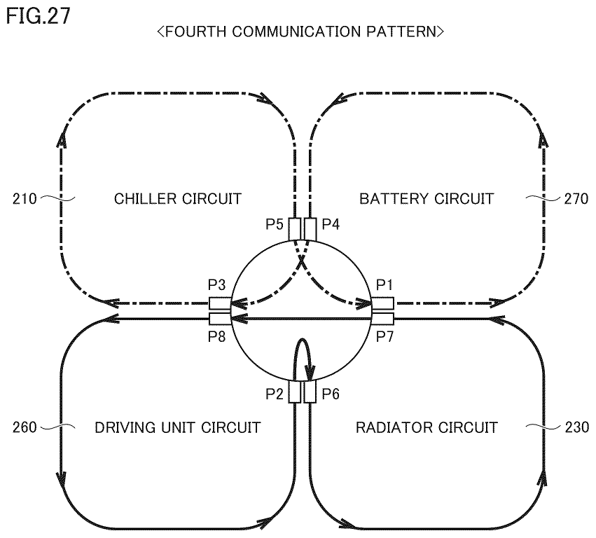

In the fourth communication pattern (see FIG. 27), eight-way valve 280 forms a path that communicates port P5 and port P1 with each other, a path that communicates port P4 and port P3 with each other, a path that communicates port P7 and port P8 with each other, and a path that communicates port P2 and port P6 with each other. Thus, battery circuit 270 and chiller circuit 210 are connected together in series, and driving unit circuit 260 and radiator circuit 230 are connected together in series.

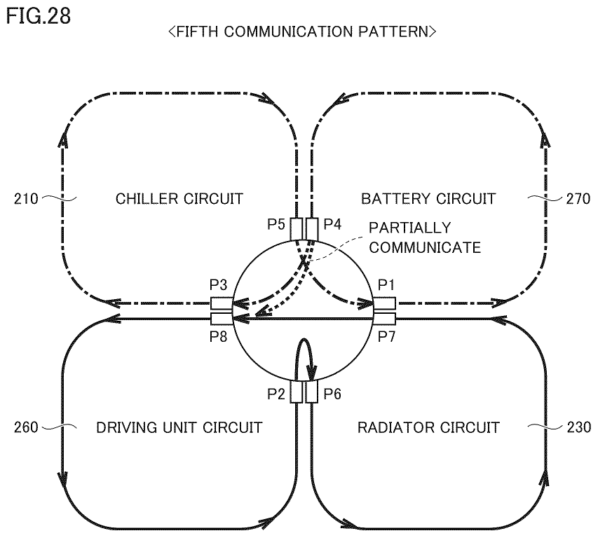

In the fifth communication pattern (see FIG. 28), as with the fourth communication pattern, eight-way valve 280 forms a path that communicates port P5 and port P1 with each other, a path that communicates port P4 and port P3 with each other, a path that communicates port P7 and port P8 with each other, and a path that communicates port P2 and port P6 with each other. Thus, battery circuit 270 and chiller circuit 210 are connected together in series, and driving unit circuit 260 and radiator circuit 230 are connected together in series. In addition, in the fifth communication pattern, a path that communicates port P4 and port P8 with each other is formed. Thus, battery circuit 270 and driving unit circuit 260 partially communicate with each other.

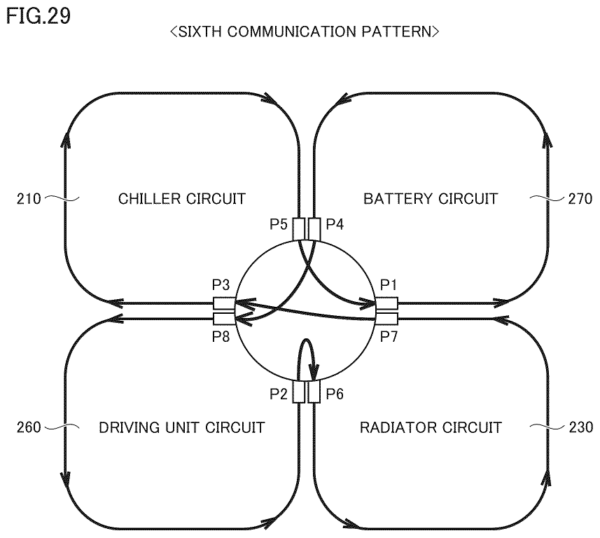

In the sixth communication pattern (see FIG. 29), eight-way valve 280 forms a path that communicates port P5 and port P1 with each other, a path that communicates port P4 and port P8 with each other, a path that communicates port P2 and port P6 with each other, and a path that communicates port P7 and port P3 with each other. In this case, battery circuit 270, driving unit circuit 260, radiator circuit 230, and chiller circuit 210 are all connected together in series.

<Circuit Modes>

In each of the following circuit modes, in order to avoid complication, only main components of the components of thermal management circuit 200 shown in FIG. 23 will be described and shown.

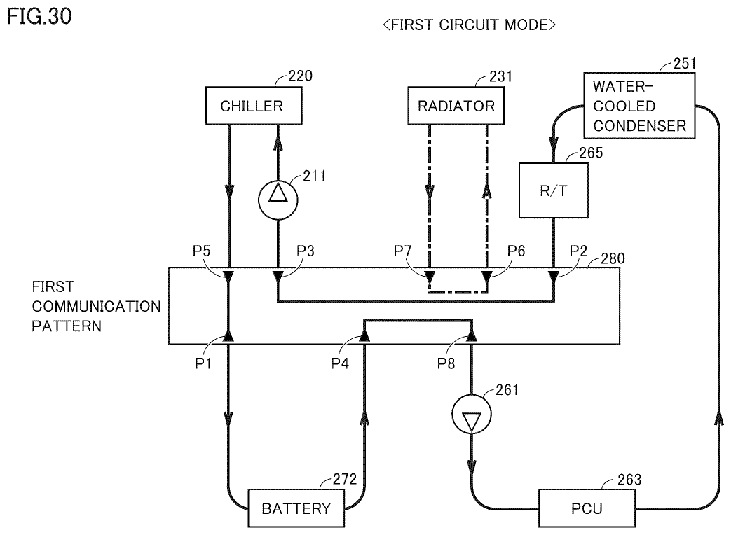

FIG. 30 is a diagram for illustrating a first circuit mode according to the second embodiment. In the first circuit mode, eight-way valve 280 is set to the first communication pattern (see FIG. 24). Thus, battery circuit 270, driving unit circuit 260, and chiller circuit 210 are connected together in series. More specifically, a first path is formed in which the heat medium flows in the order of port P8, water pump 261, PCU 263, water-cooled condenser 251, reservoir tank 265, port P2, port P3, water pump 211, chiller 220, port P5, port P1, battery 272, port P4 and port P8. Separately, a second path is formed in which the heat medium flows in the order of port P6, radiator 231, port P7, and port P6.

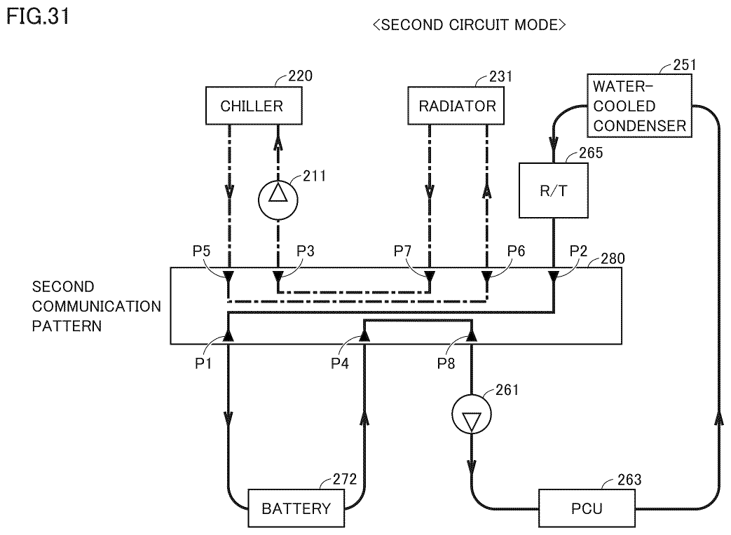

FIG. 31 is a diagram for illustrating a second circuit mode according to the second embodiment. In the second circuit mode, eight-way valve 280 is set to the second communication pattern (see FIG. 25). Thus, battery circuit 270 and driving unit circuit 260 are connected together in series. More specifically, a first path is formed in which the heat medium flows in the order of port P1, battery 272, port P4, port P8, water pump 261, PCU 263, water-cooled condenser 251, reservoir tank 265, port P2, and port P1. Chiller circuit 210 and radiator circuit 230 are connected together in series. More specifically, a second path is formed in which the heat medium flows in order of port P3, water pump 211, chiller 220, port P5, port P6, radiator 231, port P7, and port P3.

FIG. 32 is a diagram for illustrating a third circuit mode according to the second embodiment. In the third circuit mode, eight-way valve 280 is set to the third communication pattern (see FIG. 26). Thus, battery circuit 270 and driving unit circuit 260 are connected together in series. Chiller circuit 210 and radiator circuit 230 are connected together in series. A specific manner of connection of these series-connected circuits is the same as that described in the second circuit pattern.

In addition, in the third circuit mode, port P2 and port P3 of eight-way valve 280 partially communicate with each other. As described above, instead of this, port P7 and port P8 may partially communicate with each other. For convenience of illustration, FIG. 32 shows a configuration in which port P7 and port P8 partially communicate with each other. With this, the pressure of the heat medium in battery circuit 270 can be released to the series-connected circuit constituted of chiller circuit 210 and radiator circuit 230. Further, in the configuration in which port P7 and port P8 partially communicate with each other, the respective inlets of the water pumps are connected together, with the result that the pressure at the inlet of water pump 261 is equal to the pressure at the inlet of water pump 211. Thus, air bubbles (cavitation) can be suppressed from being generated due to the pressure at the inlet of the water pump being a negative pressure.

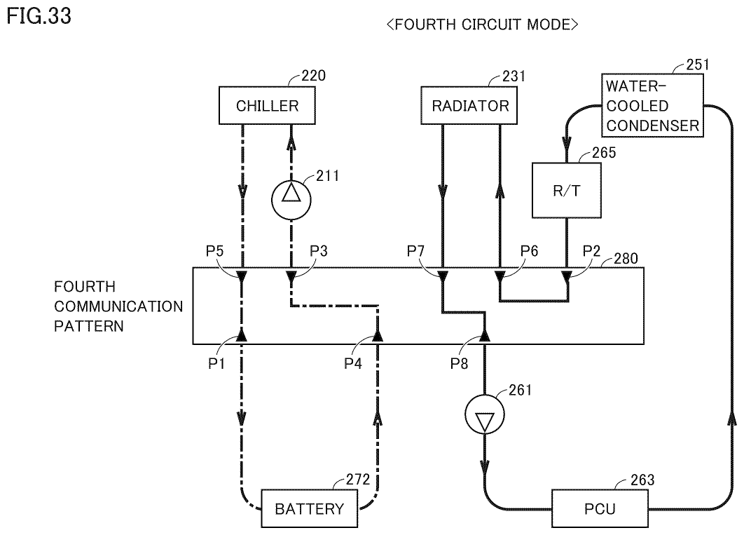

FIG. 33 is a diagram for illustrating a fourth circuit mode according to the second embodiment. In the fourth circuit mode, eight-way valve 280 is set to the fourth communication pattern (see FIG. 27). Thus, battery circuit 270 and chiller circuit 210 are connected together in series. More specifically, a first path is formed in which the heat medium flows in the order of port P1, battery 272, port P4, port P3, water pump 211, chiller 220, port P5, and port P1. Driving unit circuit 260 and radiator circuit 230 are connected together in series. More specifically, a second path is formed in which the heat medium flows in the order of port P8, water pump 261, PCU 263, water-cooled condenser 251, reservoir tank 265, port P2, port P6, radiator 231, port P7, and port P8.

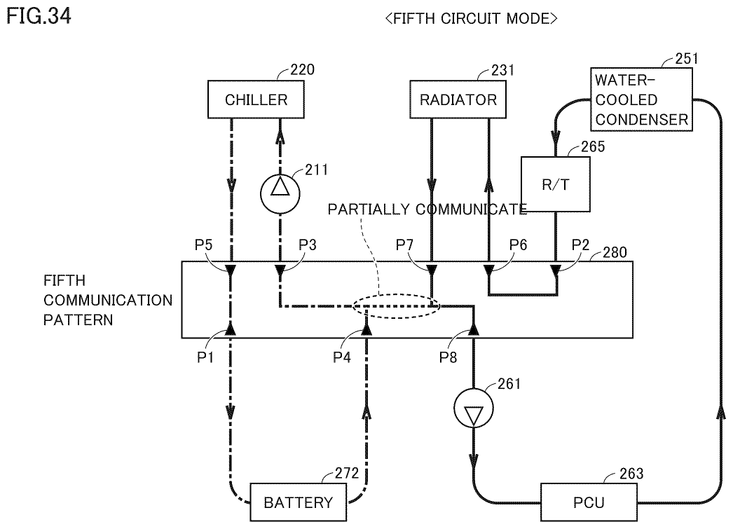

FIG. 34 is a diagram for illustrating a fifth circuit mode according to the second embodiment. In the fifth circuit mode, eight-way valve 280 is set to the fifth communication pattern (see FIG. 28). Thus, battery circuit 270 and chiller circuit 210 are connected together in series, and driving unit circuit 260 and radiator circuit 230 are connected together in series. A specific manner of connection of these series-connected circuits is the same as that described in the third circuit pattern.

In addition, in the fifth circuit mode, port P4 and port P8 of eight-way valve 280 partially communicate with each other. With this, the pressure of the heat medium in battery circuit 270 can be released to driving unit circuit 260. Since reservoir tank 265 is provided in driving unit circuit 260, reservoir tank 265 of driving unit circuit 260 can absorb pressure increase of the heat medium caused by a temperature change of the heat medium circulating in battery circuit 270. Therefore, pressure applied to each component of battery circuit 270 can be suppressed to be less than the withstanding pressure.

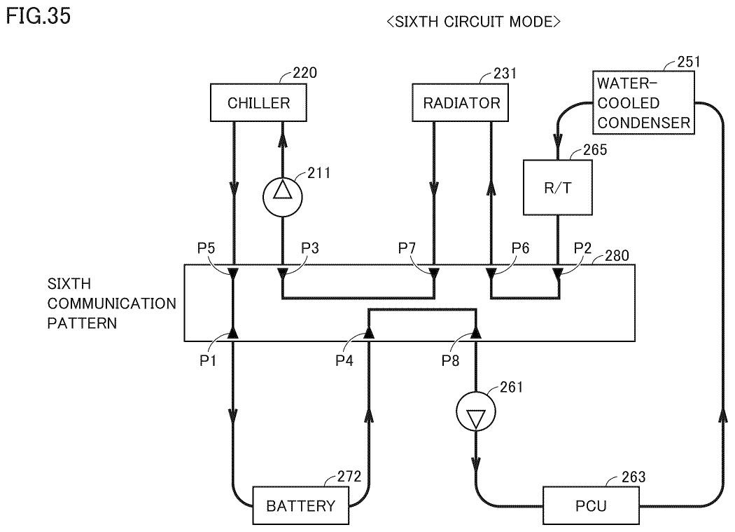

FIG. 35 is a diagram for illustrating a sixth circuit mode according to the second embodiment. In the sixth circuit mode, eight-way valve 280 is set to the sixth communication pattern (see FIG. 29). Thus, battery circuit 270, driving unit circuit 260, radiator circuit 230, and chiller circuit 210 are all connected together in series. More specifically, a path is formed in which the heat medium flows in the order of port P1, battery 272, port P4, port P8, water pump 261, PCU 263, water-cooled condenser 251, reservoir tank 265, port P2, port P6, radiator 231, port P7, port P3, water pump 211, chiller 220, port P5, and port P1.

As described above, thermal management system 2 according to the second embodiment includes eight-way valve 280 configured to realize the fifth communication pattern (see FIG. 28). In the fifth circuit mode (see FIG. 34) to which the fifth communication pattern is applied, the narrow path (partial communication path between port P4 and port P8) that connects between battery circuit 270 and driving unit circuit 260 is formed between these two circuits. Via this narrow path, the pressure of the heat medium flowing in battery circuit 270 is released to driving unit circuit 260, with the result that the pressure increase of battery circuit 270 can be absorbed by reservoir tank 265 provided in driving unit circuit 260. Therefore, according to the second embodiment, even when battery circuit 270 is not provided with the reservoir tank, a trouble due to expansion of the heat medium can be prevented.

The configuration in which five-way valve 180 is employed has been described in the first embodiment, and the configuration in which eight-way valve 280 is employed has been described in the second embodiment. Thus, the multi-way valve according to the present disclosure desirably includes at least four ports.

It should be noted that in the second embodiment, driving unit circuit 260 corresponds to the “first circuit” according to the present disclosure. Battery circuit 270 corresponds to the “second circuit” according to the present disclosure. In the second embodiment, the “third circuit” (bypass path) according to the present disclosure is not provided. The first circuit mode, the second circuit mode, and the sixth circuit mode each correspond to the “first mode” according to the present disclosure. The fifth circuit mode corresponds to the “second mode” according to the present disclosure. The fourth circuit mode corresponds to the “third mode” according to the present disclosure.

Although the embodiments of the present disclosure have been described and illustrated in detail, it is clearly understood that the same is by way of illustration and example only and is not to be taken by way of limitation, the scope of the present disclosure being interpreted by the terms of the appended claims. The scope of the present disclosure is defined by the terms of the claims, and is intended to include any modifications within the scope and meaning equivalent to the terms of the claims.

What is claimed is:

1. A thermal management system comprising:
a thermal management circuit in which a heat medium flows, the thermal management circuit having a first circuit including a reservoir and a second circuit not including the reservoir;
a switching valve including a plurality of ports each connected to the first circuit or the second circuit; and
a controller that controls the switching valve to switch a plurality of modes with regard to a flow path for the heat medium in the thermal management circuit, wherein
the plurality of modes include a first mode and a second mode,
the first mode is a mode in which the first circuit and the second circuit are connected together in series, and
the second mode is a mode in which the first circuit and the second circuit are connected together in parallel and part of the heat medium flowing in the second circuit flows to the first circuit via the switching valve.

2. The thermal management system according to claim 1, wherein
the plurality of modes further include a third mode, and
the third mode is a mode in which the first circuit and the second circuit are connected together in parallel so as to avoid mixing of the heat medium flowing in the first circuit and the heat medium flowing in the second circuit.

3. The thermal management system according to claim 1, wherein
the plurality of ports are at least four ports, and
the at least four ports include two ports each connected to the first circuit and two other ports each connected to the second circuit.

4. The thermal management system according to claim 3, wherein
the thermal management system is mounted on a vehicle including a driving device and a battery,
the first circuit is a circuit in which the heat medium flows to exchange heat with the driving device, and
the second circuit is a circuit in which the heat medium flows to exchange heat with the battery.

5. The thermal management system according to claim 4, wherein
the thermal management circuit further includes a third circuit in which the heat medium flows to bypass the battery, the third circuit not including the reservoir,
the plurality of modes further include a fourth mode, and
the fourth mode is a mode in which the first circuit and the third circuit are connected together in series.

6. A switching valve connected to a thermal management circuit including a first circuit and a second circuit, the switching valve comprising:
a case provided with a plurality of ports each connected to the first circuit or the second circuit; and
a valve body that is accommodated in the case and that controls flow of a heat medium, wherein
the valve body is provided with a communication portion that is able to switch a plurality of patterns with regard to a manner of communication of the heat medium between the plurality of ports,
the plurality of patterns include a first pattern and a second pattern,
the first pattern is a pattern in which the first circuit and the second circuit are connected together in series, and
the second pattern is a pattern in which the first circuit and the second circuit are connected together in parallel and part of the heat medium flowing in the second circuit flows to the first circuit via the valve body.

7. The switching valve according to claim 6, wherein
the plurality of ports are at least four ports, and
the at least four ports include two ports each connected to the first circuit and two other ports each connected to the second circuit.

8. The switching valve according to claim 7, wherein
the case includes
a first space to which at least three ports of the at least four ports are connected, and
a second space to which at least one port of the at least four ports is connected,
the first space and the second space are partitioned by the valve body,
the first space is divided into a plurality of spaces by a plurality of partition walls, and
the communication portion includes
a first communication portion that communicates two spaces of the plurality of spaces with each other, and
a second communication portion that communicates the first space and the second space with each other.

9. A method of controlling a thermal management system including a thermal management circuit and a switching valve, wherein
the thermal management circuit has a first circuit including a reservoir and a second circuit not including the reservoir, and
the switching valve includes a plurality of ports each connected to the first circuit or the second circuit,
the method comprising controlling the switching valve to switch a plurality of modes with regard to a flow path for a heat medium in the thermal management circuit, wherein
the plurality of modes include a first mode and a second mode,
the first mode is a mode in which the first circuit and the second circuit are connected together in series, and
the second mode is a mode in which the first circuit and the second circuit are connected together in parallel and part of the heat medium flowing in the second circuit flows to the first circuit via the switching valve.
